(19) United States
(12) Patent Application Publication
(10) Pub. No.: US 2026/0078992 A1
(43) Pub. Date: Mar. 19, 2026

(54) SYSTEMS, METHODS, AND DEVICES FOR COMMERCIAL BLASTING OPERATIONS

(71) Applicant: Orica International Pte Ltd, Singapore (SG)

(72) Inventors: Steven E. KOTSONIS, Melbourne, Victoria (AU); Brian LAVERY, Melbourne (AU); Aaron Cope MAHER, Bentleigh East (AU); Adrian CROUCH, West Footscray (AU); Kenneth NG, Coburg (AU); Leif Robert SLOAN, Singapore (SG)

(73) Assignee: Orica International Pte Ltd, Singapore (SG)

(21) Appl. No.: 19/399,271

(22) Filed: Nov. 24, 2025

Related U.S. Application Data
(63) Continuation of application No. 18/006,215.
(60) Provisional application No. 63/055,361, filed on Jul. 23, 2020.

(51) Int. Cl. F42D 1/045; H04Q 9/00

(52) U.S. Cl. CPC F42D 1/045; H04Q 9/00; H04Q 2209/40; H04Q 2209/883

(57) ABSTRACT

A system for commercial blasting operations includes at least one commercial blasting system element in the form of a translocation monitoring unit (TMU), configured to reside in a borehole, which is configured to be couplable to, coupled to or incorporated in a wireless initiation device that is configured for commercial blasting. The TMU includes: an inertial measurement unit (IMU) configured to measure spatial displacement of the IMU based on one or more movement sensors of (internal to) the IMU; and/or an externally-generated localization signal reception unit configured wirelessly receive one or more types of externally-generated localization signals transmitted by one or more localization signal sources disposed external to the TMU and external to the wireless initiation device. The system includes an electronic processing unit and memory configured to evaluate spatial displacement, and to control the wireless initiation device to automatically transition its state based on the evaluated spatial displacement.

### RELATED APPLICATIONS

The present application is a continuation of U.S. patent application Ser. No. 18/006,215, filed Jan. 20, 2023, entitled “SYSTEMS, METHODS, AND DEVICES FOR COMMERCIAL BLASTING OPERATIONS”, which is a U.S. National Stage of International Application No. PCT/SG2021/050432, filed on Jul. 23, 2021, entitled “SYSTEMS, METHODS, AND DEVICES FOR COMMERCIAL BLASTING OPERATIONS,” which claims priority to U.S. Patent Application No. 63/055,361, filed Jul. 23, 2020, entitled “TRANSLOCATION-BASED SYSTEMS, METHODS, AND DEVICES FOR ENHANCING THE SAFETY OF COMMERCIAL BLASTING OPERATIONS,” all of which are hereby incorporated by reference in their entireties.

### TECHNICAL FIELD

Aspects of the present disclosure relate to systems, apparatuses, devices, methods, processes, and procedures in which commercial blasting system elements (e.g., wireless initiation devices, translocation monitoring units, etc.) are configured for use in commercial blasting operations for enhancing the safety of commercial blasting systems and commercial blasting operations.

### BACKGROUND

A key benefit of wireless blasting systems, such as the Orica™ Webgen™ system (Orica International Pte Ltd, Singapore) in which Webgen™ wireless initiation devices are used to carry out commercial blasting operations is that, unlike wire-based blasting systems, the wireless initiation devices are not tethered by a physical lead wire to a remote blast-box, from which it receives the command and/or required energy to FIRE. Rather, a Webgen™ initiation device receives its signal to FIRE via a wireless signal transmitted using low-frequency signal transmission, which is not blocked by the earth and travels over extended distances, with practical range in the 100 m to 1 km range. Consequently, at deployment, a Webgen™ primer carries on-board the energy required to FIRE, which is managed by specifically designed electronics to ensure that it will FIRE, when, and only when, it receives an appropriate FIRE command. This lack of physical lead wires significantly reduces the misfire rate and allows innovative blast designs not previously possible. Removal of lead wires, however, means that in theory, any properly encoded initiation device(s) can be initiated if in wireless signal reception range, regardless of whether or not the initiation device(s) reside(s) in the blasthole(s).

Central to the safety of commercial blasting operations is withholding the energy to explosively initiate blasting compositions until humans are not in to the line-of-fire. This practice pre-dates the invention of the safety fuse in 1831 and the invention of the electric detonator in 1910, whereby a match or dynamo/battery, respectively, were not applied to the lead-line until all people evacuated.

Administrative and ‘soft’ procedural/engineering controls can aid wireless blasting safety, which are effective but not ideal. A need exists for stricter or hard/engineering controls to enhance or maximize the likelihood that the correct primer will operate only at or in its intended location. Such hard/engineering controls should be robust and reliable (e.g., highly reliable) under a wide or full range of commercial blasting operating environments, conditions, and situations.

It is desired to address or ameliorate one or more disadvantages or limitations associated with the prior art, or to at least provide a useful alternative.

### BRIEF DESCRIPTION OF THE DRAWINGS

Some embodiments of the present invention are hereinafter described, by way of example only, with reference to the accompanying drawings in which:

FIG. 1 is a block diagram of an example prior-art wireless initiation device and an example encoding apparatus/device or “encoder”.

FIGS. 2A-2E are block diagrams showing aspects of particular embodiments of wireless initiation devices or wireless electronic blasting (WEB) devices equipped with translocation monitoring units (TMUs), or TMU-WEB devices, in accordance with the present disclosure.

FIG. 3 is a block diagram showing aspects of a TMU-WEB device communication unit in accordance with an embodiment of the present disclosure.

FIGS. 4A-4B are block diagrams showing aspects of TMUs in accordance with certain embodiments of the present disclosure.

FIGS. 5A-5E are schematic illustrations showing representative aspects of in-field/on-site TMU-WEB device activation/programming and deployment in boreholes or blastholes for purpose of carrying out a particular commercial blasting operation in accordance with particular embodiments of the present disclosure. FIG. 5C shows the encoder communicating encoding/TMU activation data to the TMU-WEB device, and the loading apparatus communicating translocation reference data to TMU-WEB device; or the loading apparatus or authorized worker activating TMU-WEB device switch(es). FIG. 5D shows an Encoder communicating with TMU-WEB device, and a loading apparatus communicating translocation reference data to the TMU-WEB device; or a loading apparatus or authorized worker activating TMU-WEB device switch(es). FIG. 5E shows an Automated/Autonomous Encoding and Loading Apparatus encoding a TMU-WEB device, and communicating translocation reference data to a TMU-WEB device as part of borehole loading procedure.

FIGS. 6A-6D show certain aspects pertaining to estimating, monitoring, determining, or calculating TMU-WEB device position or displacement/translocation (e.g., net displacement/translocation) away from at least one spatial zero reference location or point relative to at least one corresponding maximum allowable translocation or displacement distance (e.g., a maximum allowable net displacement/translocation distance) and/or at least one set of geofence boundaries in accordance with particular embodiments of the present disclosure.

FIGS. 6E-6F illustrate non-limiting representative aspects of TMU-WEB device translocation monitoring relative to multiple spatial zero reference points P₁, P₂ and/or multiple sets of geofence boundaries G₁, G₂ (e.g., each of which defines a geofence corresponding to a different or distinguishable physical spatial volume) at particular times.

FIG. 7A is a schematic illustration of a representative set of spatial zones or geofences and a representative set of translocation distance thresholds definable or defined in accordance with particular embodiments of the present disclosure.

FIG. 7B is a flow diagram of a representative TMU-WEB device translocation-based operational state management process in accordance with an embodiment of the present disclosure, associated with or corresponding to the representative set of spatial zones or geofences and the representative set of translocation distance thresholds of FIG. 7A.

### SUMMARY

Disclosed herein is a system (for commercial blasting operations), the system including:
at least one commercial blasting system element in the form of a translocation monitoring unit (TMU), configured to reside in a borehole, which is configured to be couplable to, coupled to or incorporated in a wireless initiation device that is configured for commercial blasting, wherein the TMU includes:
   an inertial measurement unit (IMU) configured to measure spatial displacement of the IMU based on one or more movement sensors of (internal to) the IMU, and/or
   an externally-generated localization signal reception unit configured wirelessly receive one or more types of externally-generated localization signals transmitted by one or more localization signal sources disposed external to the TMU and external to the wireless initiation device; and
an electronic processing unit and memory configured to evaluate spatial displacement of the wireless initiation device based on the measured spatial displacement of the IMU and/or the externally-generated localization signals and selectively generate and issue a state transition signal or command, by which the wireless initiation device can be or is transitioned to a safe/standby mode or a reset/disabled state, after the wireless initiation device has been programmed/encoded (and has been operating in a near-fully or fully operational state), if the evaluated spatial displacement is greater than at least one translocation distance threshold, such that the wireless initiation device automatically transitions its state based on its evaluated spatial displacement.

The electronic processing unit and memory may be configured to transition the state to the safe/standby mode or the reset/disabled state when the evaluated spatial displacement is greater than: a first translocation distance threshold defined as a radial distance away from a geofence/beacon unit; a second translocation distance threshold defined as a (selected) maximum translocation distance from one or more (selected) spatial reference locations; and/or a third translocation distance threshold corresponding substantially to a borehole depth following loading of the wireless initiation device into the borehole.

The electronic processing unit and memory may be configured to transition the state to a fully enabled or fully activated operational state, in which the wireless initiation device can process and carry out a FIRE command, or an ARM command followed by a FIRE command, after the wireless initiation device has been programmed/encoded, when the evaluated spatial displacement is greater than a selected significant fraction of the borehole in a direction toward a borehole location at which the wireless initiation device is intended to be disposed according to a blast plan.

The one or more movement sensors internal to the IMU may measure the spatial displacement relative to or along or in one, two or three orthogonal spatial directions or dimensions or axes, and the one or more movement sensors may include at least one accelerometer, one gyroscope, and optionally one magnetometer per axis for each of one, two or three of the three orthogonal spatial directions or dimensions or axes.

The system may include the wireless initiation device, configured to reside in the borehole, including: a communication and control (CC) unit (120); and an initiation element (optionally an electronic detonator) and/or an initiation unit configured for initiating an explosive composition.

The TMU may be couplable to the wireless initiation device, wherein the TMU includes a TMU housing module (202) and may be configured for wire-based and/or wireless communication with a communication unit (124) and/or an initiation control unit (126) in the wireless initiation device.

The TMU may be configured to be turned on/powered up or transitioned from an inactive or quiescent/sleep/standby mode or state to an active state by way of coupling of the TMU housing unit (202) to the wireless initiation device

The system may include one or more switches/buttons carried by the TMU and/or the wireless initiation device, and the TMU may be configured to be turned on/powered up or transitioned from an inactive or quiescent/sleep/standby mode or state to an active state by way of activation (e.g., manual activation) of the one or more switches/buttons.

The system may include one or more visual indicator devices, carried by the TMU and/or the wireless initiation device, configured for outputting at least one signal or datum/data indicating a current status or state (e.g., an operational status/state) of the system based on a current or most-recent TMU spatial location determined from the evaluated spatial displacement, optionally wherein the TMU is configured to output visual indicator signals for the visual indicator devices for visibly or visually indicating a current state of the TMU and/or the wireless initiation device.

The electronic processing unit and the memory may include integrated circuitry configured for tracking, estimating, detecting, monitoring, measuring, and/or determining a current spatial zone/region/location/position and/or displacement of the TMU relative to the externally-generated localization signals that have been received, and/or the spatial reference location data, in accordance with program instructions stored in the memory that are executed by the electronic processing unit.

The system may include an encoder (i.e., an encoding apparatus configured to transition the wireless initiation device from an inactive or disabled state to an active or enabled state in an encoding procedure), wherein the encoder is configured to send signals (e.g., wireless signals) to the TMU:
to power up, wake up, or transition the TMU to a responsive, active, or fully active state;
to output or communicate the externally-generated localization signals in proximity to, in the vicinity of, or toward or to the TMU by way of a geofence/beacon unit carried by, couplable/attachable to, or built into the encoder;
to transfer to the TMU a minimum acceptable signal strength, level, amplitude, or magnitude threshold corresponding to reliable detection of the externally-generated localization signals;
to transfer to the TMU a spatial reference location (data) correlated with or corresponding to a current geospatial location of the encoder (e.g., at which the encoding procedure occurs) and defining a spatial zero reference location or point for the TMU; and/or
to transfer to the TMU data establishing, for the TMU/wireless initiation device, at least one maximum allowable displacement distance (e.g., a maximum allowable net displacement distance, and/or a maximum allowable cumulative, aggregated, or accumulated spatial displacement) and/or one or more geofence boundaries defined with respect to a/the spatial reference location.

The system may include the one or more localization signal sources, and optionally including:
an encoder (i.e., an encoding apparatus configured to transition the wireless initiation device from an inactive or disabled state to an active or enabled state in an encoding procedure) carrying at least one of the one or more localization signal sources;
a loading system (e.g., an MMU) carrying at least one of the one or more localization signal sources; and/or
one or more ground-based platform structures (e.g., a tripod) carrying at least one of the one or more localization signal sources.

The system may include a loading system with a communication unit configured to generate signals/commands shortly or just before or as the wireless initiation device is loaded into the borehole, wherein on receipt of the signals/commands, the TMU and the electronic processing unit and memory are configured to:
transition the state to a fully enabled or fully activated operational state, in which the wireless initiation device can process and carry out a FIRE command, or an ARM command followed by a FIRE command;
activate the TMU;
clear/reset/zero any accumulated translocation/movement values (data) generated and stored by way of the IMU;
establish a spatial zero reference location of the TMU; and/or
initiate TMU monitoring of net TMU device translocation by the evaluated spatial displacement,
wherein the loading system optionally includes a magazine configured to store a plurality of wireless initiation devices,
wherein the loading system optionally carries at least one of the one or more localization signal sources.

The TMU and the electronic processing unit and memory may be configured to:
determine whether the externally-generated localization signals are currently being reliably received (e.g., indicating that the TMU 200 is within reliable signal reception range of at least one geofence/beacon unit 80, and is receiving geofence/beacon signals output thereby) (2112); and if so,
clear/reset/zero any accumulated translocation distance values (data) (e.g., a set of accumulated translocation values corresponding to displacement along one or more spatial dimensions) generated and stored by way of the IMU (210) (2114).

Disclosed herein is a method (for commercial blasting operations), the method including:
automatically evaluating spatial displacement of a wireless initiation device that is configured for commercial blasting based on:
one or more movement sensors of an inertial measurement unit (IMU), and/or
one or more types of externally-generated localization signals transmitted by one or more localization signal sources disposed external to the IMU and external to the wireless initiation device; and
(automatically) generating and issuing a state transition signal or command by which the wireless initiation device can be or is transitioned to a safe/standby mode or a reset/disabled state, after the wireless initiation device has been programmed/encoded, if the evaluated spatial displacement is greater than at least one translocation distance threshold, such that the wireless initiation device automatically transitions its state based on the evaluated spatial displacement.

The wireless initiation device includes a first power unit/one or more power sources (e.g., including one or more batteries and/or capacitors, and typically associated power management circuitry) coupled to each of a device communication unit, an initiation control unit, and optionally the TMU.

The electronic processing unit may include: a TMU processing unit that can correspond to or include or be a microcontroller, microprocessor, or state machine. The memory may include a TMU memory. The electronic processing unit and the memory may be provided by an initiation control unit in the wireless initiation device.

The wireless initiation device is a form of wireless electronic blasting (WEB) device, i.e., a device configured to reside in a borehole for commercial blasting operations.

Disclosed herein is a system (for commercial blasting operations), the system including:
a loading system with a communication unit configured to generate signals/commands shortly or just before or as a wireless initiation device is loaded into a borehole, wherein on receipt of the signals/commands, an electronic processing unit and memory of the wireless initiation device and/or of a commercial blasting system element (e.g., a translocation monitoring unit) coupled to or incorporated in the wireless initiation device are configured to: transition the wireless initiation device to a fully enabled or fully activated operational state, in which the wireless initiation device can process and carry out a FIRE command, or an ARM command followed by a FIRE command.

The loading system may include an encoder (i.e., an encoding apparatus configured to automatically transition the wireless initiation device from an inactive or disabled state to an active or enabled state in an encoding procedure), and optionally a magazine configured to store a plurality of wireless initiation devices.

Disclosed herein is a method (for commercial blasting operations), the method including:
a loading system automatically generating signals/commands shortly or just before or as a wireless initiation device is loaded into a borehole;
the wireless initiation device, and/or a commercial blasting system element (e.g., a translocation monitoring unit) coupled to or incorporated in the wireless initiation device, receiving the signals/commands; and
based on the signals/commands, automatically transitioning the wireless initiation device to a fully enabled or fully activated operational state, in which the wireless initiation device can process and carry out a FIRE command, or an ARM command followed by a FIRE command.

### DETAILED DESCRIPTION

The reference herein to any prior publication (or information derived from it), or to any matter which is known, is not, and should not be taken as an acknowledgment or admission or any form of suggestion that such prior publication (or information derived from it) or known matter forms part of the common general knowledge in the field of endeavor to which this specification relates. Herein, unless the context stipulates or requires otherwise, any use of the word “comprise,” and variations such as “comprises” and “comprising,” imply the inclusion of a stated element or procedure/step or group of elements or procedures/steps but not the exclusion of any other element or procedures/step or group of elements or procedures/steps. Reference to one or more embodiments, e.g., as various embodiments, many embodiments, several embodiments, multiple embodiments, some embodiments, certain embodiments, particular embodiments, specific embodiments, or a number of embodiments, need not or does not mean or imply all embodiments. Reference to a number of embodiments means at least one embodiment.

As used herein, the term “set” corresponds to or is defined as a non-empty finite organization of elements that mathematically exhibits a cardinality of at least 1 (i.e., a set as defined herein can correspond to a unit, singlet, or single element set, or a multiple element set), in accordance with known mathematical definitions (for instance, in a manner corresponding to that described in An Introduction to Mathematical Reasoning: Numbers, Sets, and Functions, “Chapter 11: Properties of Finite Sets” (e.g., as indicated on p. 140), by Peter J. Eccles, Cambridge University Press (1998)). Thus, a set includes at least one element. In general, an element of a set can include or be one or more portions of a structure, an object, a process, a composition, a physical parameter, or a value depending upon the type of set under consideration. The presence of “/” in a FIG. or text herein is understood to mean “and/or” unless otherwise indicated. The recitation of a particular numerical value or value range herein is understood to include or be a recitation of an approximate numerical value or value range, for instance, within +/−20%, +/−15%, +/−10%, +/−5%, +/−2.5%, +/−2%, +/−1%, +/−0.5%, or +/−0%. The term “essentially all” or “substantially” can indicate a percentage greater than or equal to 90%, for instance, greater than 92.5%, 95%, 97.5%, 99%, or 100%. The term “significant fraction” can indicate a percentage greater than or equal to 20%, for instance, greater than 25%, 50%, 75%, 80%, or 100%.

Initiation devices in the context of the present disclosure include or are devices that are configurable or which are configured for initiating explosive materials, compositions, or composition formulations (e.g., explosively initiating causing detonation of explosive materials such as emulsion explosive compositions or formulations loaded into boreholes).

### Overview

In accordance with various embodiments of the present disclosure that relate to or involve wireless initiation devices, hard/engineering control subsystems, apparatuses, elements, or devices (e.g., built-into each initiation device) are employed to enhance or maximize the likelihood or ensure that the wireless initiation devices (a) will only operate or fully operate and/or be capable of processing and carrying out FIRE commands if they reside in a correct, predetermined, pre-planned, and/or intended region, area, or location; and correspondingly, (b) will not operate or fully operate and/or be capable of processing and carrying out FIRE commands if they do not reside in their correct, predetermined, pre-planned, and/or intended regions, areas, or locations. In multiple embodiments, the hard/engineering control subsystems, apparatuses, elements, or devices are carried by, attachable to, or built-into the wireless initiation device itself.

While initiation devices can carry or include one or more types of state sensing elements, conventional state sensing elements are limited to detecting only certain types of environmental conditions, such as a limited number of specific conditions inside a borehole or blasthole, or another environment (e.g., a dark environment in the case of light sensing elements) that can be similar to or mimic borehole or blasthole conditions.

A wireless initiation device can carry or be equipped with an auxiliary localization/positioning unit/device configured for receiving wirelessly-communicated localization/positioning signals. For instance, a wireless initiation device can be equipped with (a) a Global Navigation Satellite System (GNSS) unit/device (e.g., a Global Positioning Satellite (GPS) chip) configured for receiving GNSS signals; and/or (b) one or more other types of auxiliary localization/positioning units/devices, such as a radio frequency (RF) beacon signal reception device configured for receiving signals corresponding to a particular radio frequency communication band, which can aid the estimation or determination/confirmation of wireless initiation device location/position. Such types of auxiliary devices, however, rely upon the reliable wireless communication/reception of externally-sourced, externally-generated, or extrinsic localization signals (i.e., localization signals generated external to the auxiliary device(s) that are configured for receiving such signals, and external to the wireless initiation device that is associated with or coupled to the auxiliary device(s)), such that the initiation device can accurately or generally accurately locate itself with reference to an intended or allowed spatial region, area, location, or position. However, externally-generated localization signals may not be reliably received or receivable by a wireless initiation device equipped with one or more of such auxiliary device(s) in multiple types of environments or situations. For instance, such a wireless initiation device cannot reliably receive or receive GNSS signals in an underground mining environment; and such a wireless initiation device may not be able to reliably receive GNSS signals or RF signals when the wireless initiation device resides in a borehole/blasthole (e.g., when the wireless initiation device is disposed more than a small distance below a borehole/blasthole collar, or more than approximately one or more meters below the borehole/blasthole collar).

Due in part to the recent and significant reduction in the cost of inertial measurement/navigation technology, a commercial blasting system element in the form of a translocation monitoring unit (TMU) that includes an inertial measurement/navigation related or inertial measurement/navigation based unit/device (e.g., analogous or corresponding to or based on a commercially available inertial measurement/navigation unit chip) is well suited for aiding, further aiding, or enabling (a) the localization of a TMU-equipped wireless initiation device, including to at least some extent in various embodiments self-contained and/or self-localization of the TMU-equipped wireless initiation device (e.g., automatic or substantially automatic localization of the wireless initiation device by the TMU-equipped wireless initiation device itself at one or more times, even in the absence of the reception or reliable reception of externally-generated localization signals); as well as (b) the selective self-contained or independent management or control of the TMU-equipped wireless initiation device's operational state by way of self-contained or independent (i) based on TMU estimation, approximation, or calculation of the TMU-equipped wireless initiation device's spatial location(s)/position(s) (e.g., relative to a set of spatial zones/geofences and/or a set of translocation distance thresholds), determination by the TMU of whether the TMU-equipped wireless initiation device should or needs to be transitioned to a safe/standby mode or reset/disabled state after the TMU-equipped wireless initiation device has been programmed/encoded and has been operating in a near-fully or fully operational state (e.g., where in a fully operational state the TMU-equipped wireless initiation device is capable of responding to and carrying out WAKE, ARM, and FIRE commands), and (ii) the generation or issuance of a state transition signal or command by which the TMU-equipped wireless initiation device can be or is transitioned to the safe/standby mode or reset/disabled state.

Depending upon embodiment and/or situational details, the commercial blasting system element in the form of the TMU or a TMU-equipped wireless initiation device may or may not receive, rely upon, or utilize externally-generated or extrinsic localization signals (e.g., signals generated by a set of geofence/beacon units or devices external to the wireless initiation device and the inertial measurement/navigation unit with which it is associated or coupled) during particular localization operations that the so-equipped wireless initiation device performs (e.g., at one or more times or during one or more time periods/intervals, or in at least some physical environments or situations). The TMU is configured to reside in the borehole with the wireless initiation device such that the TMU-equipped wireless initiation device is also configured to reside in the borehole.

Embodiments in accordance with the present disclosure are directed to systems, apparatuses, devices, methods, processes, and procedures for automatically enhancing the safety of commercial blasting operations (e.g., mining, civil tunneling, construction demolition, or geophysical/seismic exploration operations) by way of commercial blasting system elements (e.g., commercial blasting subsystems, apparatuses, devices, or objects) such as initiation devices or initiation device structures (e.g., which can selectively be structurally coupled or attached to initiation devices) that carry or provide spatial displacement or translocation monitoring, estimation, or determination apparatuses, modules, units, and/or devices, which can be referred to hereafter as TMUs. A blasting system element that carries a TMU can be referred to hereafter as a TMU-equipped or TMU-enabled blasting system element.

In various embodiments, a TMU includes at least one inertial measurement/navigation unit or device, such as an inertial measurement/navigation chip and/or electronic circuitry analogous or corresponding thereto. The inertial measurement/navigation unit can receive, establish, or generate a set of spatial reference location signals/data, such as a spatial reference zero point, which can be analogous or correspond to a “dead reckoning” or a “relative reckoning” spatial location or point. The TMU can estimate, approximate, or determine an extent of spatial displacement or translocation away from the spatial zero reference point relative to or along or in one, two or three orthogonal spatial directions or dimensions or axes by way of its inertial measurement/navigation unit, in a manner that individuals having ordinary skill in the relevant art will comprehend. The spatial zero reference point can simply indicate, correspond to, or be a most-recent TMU spatial location/position at which a cumulative or net TMU spatial displacement value was cleared or (re) set to zero. In various embodiments, by way of its inertial measurement/navigation unit, the TMU can estimate, approximate, or determine an extent of spatial displacement or translocation away from the spatial zero reference point at least along a set of spatial directions corresponding to the orientation of a borehole into which the TMU-equipped blasting system element to which it corresponds is expected to be loaded or is being loaded (e.g., at least along a vertical or approximately vertical direction relative to a reference surface such as a mine bench or the surface of the earth for approximately vertical boreholes; along a horizontal or approximately horizontal direction relative to a reference surface such as a mine bench or the surface of the earth for approximately horizontal boreholes; or along or approximately along vertical and horizontal directions or a vertical and horizontal vector relative to a reference surface such as a mine bench or the surface of the earth for boreholes that are substantially or significantly non-vertical and non-parallel thereto).

In several embodiments, a TMU additionally includes an externally-generated localization signal reception unit configured for wirelessly receiving one or more types of externally-generated localization signals which were transmitted (i.e., provided or produced) by a set of localization signal sources disposed external to the TMU, and external to the TMU-equipped blasting system element with which the TMU is associated (e.g., the wireless initiation device). Such external localization signal sources can include a set of GNSS satellites, and/or a set of wireless beacon units/devices (e.g., which reside at particular in-field locations corresponding to a commercial blasting operation under consideration). Depending upon embodiment details, externally-generated localization signals can include or be electromagnetic signals and/or magnetic induction (MI) signals. For instance, an externally-generated localization signal reception unit can include or be a GNSS unit or device configured for receiving GNSS signals, and/or a wireless beacon signal reception unit/device configured for receiving externally generated wireless beacon signals (e.g., one or more wireless beacon signals, such as RF signals, generated by a set of wireless beacon units/devices or beacons, such as RF beacons, disposed in an environment external to the TMU-equipped blasting system element, for instance, a mining environment such as a particular mine bench at which the TMU-equipped blasting system element is programmed or encoded for use in an intended or specific commercial blasting operation). In certain embodiments, an externally-generated localization signal reception unit can include or be an MI signal reception unit configured for receiving MI beacon signals generated by a set of MI beacon units/devices disposed in an environment external to the TMU-equipped blasting system element.

When the TMU includes an inertial measurement/navigation unit as well as an externally-generated localization signal reception unit, while the TMU reliably receives or receives externally-generated localization signals (e.g., GNSS signals and/or wireless beacon unit/device signals, which the TMU may require to be above a minimum acceptable signal strength, level, amplitude, or magnitude threshold in order to be considered reliable or usable), depending upon embodiment details (a) translocation data generated by the inertial measurement/navigation unit need not be used or generated (e.g., because the TMU-equipped blasting element to which the TMU corresponds remains outside of a borehole into which the TMU-equipped blasting element is to be loaded, yet within reliable signal reception range of an external localization signal source); (b) translocation data generated by the inertial measurement/navigation unit can be repeatedly/periodically (re) calibrated relative to the externally-generated localization signals to reduce or minimize accumulated errors associated with such translocation data; or (c) the inertial measurement/navigation unit can remain inactive or be periodically or repeatedly cleared/reset such that translocation data generated by the inertial measurement/navigation unit, accumulated errors associated with such translocation data, and a spatial zero reference point used by the inertial measurement/navigation unit are cleared/zeroed or discarded.

In several embodiments in which the TMU includes an inertial measurement/navigation unit as well as an externally-generated localization signal reception unit, while the TMU reliably receives or can reliably receive externally-generated localization signals (e.g., GNSS signals and/or wireless beacon unit/device signals), the TMU can use the externally-generated localization signals it receives, and possibly in certain embodiments also translocation data generated by its inertial measurement/navigation unit, to estimate, approximate, or determine whether the TMU-equipped blasting system element with which it is associated remains within or has been translocated beyond a first, first allowable/acceptable, preferred, or expected most-safe spatial zone/region/location or position range, perimeter, or geofence, or past a first translocation distance threshold, which can be predetermined, selectable, or programmable. If the TMU determines that the TMU-equipped blasting element remains within the first, first allowable/acceptable, preferred, or expected most-safe spatial zone/region/location or position range, perimeter, or geofence, or has not moved past the first translocation distance threshold, the TMU typically need not or does not generate or issue a state transition signal or command directed to transitioning the TMU-equipped blasting element to a safe/standby mode or reset/disabled state (e.g., the TMU avoids or is prevented from generating or issuing such a state transition signal or command in such a situation). Individuals having ordinary skill in the relevant art will understand that the TMU-equipped blasting element's operational state can be set, established/defined, or reset by a programming or encoding device/encoder. In several embodiments, while the TMU-equipped blasting element remains within the first, first allowable/acceptable, preferred, or expected most-safe spatial zone/region/location or position range, perimeter, or geofence, or has not been translocated past the first allowable translocation distance, the TMU does not generate or issue a state transition signal or command, or avoids or is prevented from issuing a state transition signal or command, by which the TMU-equipped blasting device's operational state can be transitioned from an enabled/encoded state to a safe/standby mode, or reset/disabled state.

If no externally-generated localization signal reception unit is present or activated (e.g., the TMU lacks an externally-generated localization signal reception unit), or if the TMU no longer receives or no longer reliably receives externally-generated localization signals (e.g., after the TMU-equipped blasting system element has been (i) translocated to a location or position at which externally-generated localization signals cannot be received or reliably received, such as into a GNSS blind zone, or beyond/outside of signal reception zone(s)/range(s) associated with a set of geofence or beacon units/devices; or (ii) loaded in to a borehole/blasthole), by way of its inertial measurement/navigation unit in various embodiments the TMU can estimate, approximate, or determine (e.g., on a repeated or recurrent basis) whether the TMU-equipped blasting system element resides or remains within or has been translocated outside of a second, second appropriate/acceptable, or expected generally-safe spatial zone/region/location or position range, perimeter, or geofence, or past a second or maximum allowable translocation distance threshold, which can be predetermined, selectable, or programmable (e.g., the TMU can determine that the TMU-equipped blasting system element has been translocated past the second or maximum allowable translocation distance threshold if its cumulative and/or net displacement/movement in one or more spatial directions exceeds a set of threshold distances corresponding to such spatial directions, where the set of threshold distances can be predetermined, selectable, or programmable). It can be noted that in various embodiments, the second, second appropriate/acceptable, or expected generally-safe spatial zone/region/location or position range, perimeter, or geofence spatially subsumes or is larger than the first, first appropriate/acceptable, or expected most-safe spatial zone/region/location or position range, perimeter, or geofence; and the second or maximum allowable translocation distance threshold is greater than the first translocation distance threshold.

In several embodiments, the inertial measurement/navigation unit can be activated with initial, new/updated, or additional spatial reference location data (e.g., an initial, new/updated, or additional spatial reference zero point) after the TMU determines that it has moved beyond or outside of the first, first appropriate/acceptable, or expected most-safe spatial zone/region/location or position range, perimeter or geofence, or has travelled past the first translocation distance threshold, and the inertial measurement/navigation unit can generate translocation data relative to the initial, new/updated, or additional spatial reference location data. If the TMU determines that it has been displaced or resides beyond the second, second appropriate/acceptable, or expected generally-safe spatial zone/region, perimeter, or geofence, or past the second or maximum allowable translocation distance threshold, the TMU can further determine whether the TMU-equipped blasting system element with which it is associated or coupled should remain in its current operational state (e.g., an enabled operational state), or be transitioned to a different operational state (e.g., a safe/standby mode, or a reset/disabled state), and can selectively issue a state transition signal or command as appropriate or as needed. In various embodiments, once the TMU determines that the TMU-equipped blasting system element to which it corresponds has been displaced or resides beyond the second, second appropriate/acceptable, or expected generally-safe spatial zone/region, perimeter, or geofence, or past the second or maximum allowable translocation distance threshold, the TMU issues a state transition signal or command by which the TMU-equipped blasting system element can transition to a safe/standby mode, or a reset/disabled state.

It can be noted that in some embodiments, TMU processes, procedures, and/or operations are performed with respect to only a single appropriate/acceptable or expected safe spatial zone/region/location or position range, perimeter, or geofence, and/or a single translocation distance threshold for the TMU-equipped blasting system element; and in certain embodiments, TMU processes, procedures, and/or operations are performed with respect to more than two appropriate/acceptable or expected safe spatial zones/regions/locations or position ranges, perimeters, or geofences, and/or more than two translocation distance thresholds for the TMU-equipped blasting system element. The number and spatial extents of such appropriate/acceptable or expected safe spatial zones/regions/locations or position ranges, perimeters, or geofences, and/or translocation distance thresholds, can depend upon embodiment or commercial blasting situation details, such as commercial blasting environment safety protocols or requirements.

As further described in detail below, for a given TMU-equipped blasting system element, its TMU can be configured or activated for automatically:
(1) estimating, monitoring, tracking, or calculating TMU translocation, spatial displacement, or location/position, and hence TMU-equipped blasting system element displacement or location/position, relative to, outside of, or away from at least one detectable, predetermined, selectable, or programmably specified acceptable spatial zone/region/location or position range, or set of spatial boundaries (e.g., a spatial perimeter or geofence) established or defined in relation or with respect to (a) externally-generated localization signals received by an externally-generated localization signal reception unit of the TMU, and/or (b) a set of spatial reference locations utilized in association with or provided to an inertial measurement/navigation unit of the TMU; and
(2) selectively generating, outputting, and/or communicating at least one signal, command/instruction, and/or data that corresponds to or indicates a likelihood of whether the TMU, and hence the TMU-equipped blasting system element, (a) has been translocated or displaced beyond at least one acceptable, allowable, or expected safe spatial zone/region/location or position range or set of spatial boundaries, and/or in certain embodiments (b) remains within a particular acceptable, allowable, or expected safe spatial zone/region/location or position range or set of spatial boundaries.

Depending upon embodiment details, (i) the TMU, (ii) another portion of the TMU-equipped blasting system element that carries the TMU, and/or (iii) another portion of a blasting system with which the TMU-equipped blasting system element is associated can selectively interrogate, establish, modify/adapt, or (re) set the operational state of the TMU-equipped blasting system element based on one or more signals, commands/instructions, and/or data generated, output, or communicated by the TMU. For instance, if the TMU determines that the TMU-equipped blasting system element has been translocated outside of a particular acceptable spatial position range or “safe zone,” or beyond a maximum allowable/permissible displacement distance, or outside of a borehole/blasthole after the TMU-equipped blasting system element had already been loaded into the borehole/blasthole, then (i) the TMU, (ii) another portion of the TMU-equipped blasting system element that carries the TMU, and/or (iii) another portion of a blasting system with which the TMU-equipped blasting system element is associated can issue a signal or command to reset the operational state of the TMU-equipped blasting system element to a safe/standby mode, or a reset/deactivated/disabled state based on one or more signals, commands/instructions, and/or data generated, output, or communicated by the TMU.

In a number of embodiments, a TMU-equipped blasting system element carries at least one visual indicator (e.g., a display device, for instance, a set of light emitting diodes (LEDs), or a very low or near-zero/zero power consumption display device such as a bistable or e-ink/e-paper display device) configured for outputting at least one signal or datum/data indicating a current status or state (e.g., an operational status/state) of the TMU-equipped blasting system element based on a current or most-recent TMU spatial location relative to a spatial zone, spatial position range, or set of spatial boundaries (e.g., a geofence or spatial perimeter).

The TMU of a TMU-equipped blasting system element can be activated or transitioned to an operational or reset/initialized state by way of signal or data communication (e.g., wire-based and/or wireless communication) between a system, apparatus, or device external to the TMU and/or the TMU-equipped blasting system element. Additionally or alternatively, in some embodiments the TMU of a TMU-equipped blasting system element can be activated or reset/initialized by way of activation of one or more switches/buttons carried by the TMU-equipped blasting system element. In TMU embodiments configured for receiving externally-generated localization signals, an externally-generated localization signal reception unit can be activated or transitioned to an operational state upon or in association with TMU activation. A set of spatial reference signals/data can be provided to the TMU by way of signal or data communication (e.g., wire-based and/or wireless communication) between a system, apparatus, or device external to the TMU and/or the TMU-equipped blasting system element. Additionally or alternatively, at least a portion of spatial reference location data can be provided to or established/stored in the TMU by way of activation of one or more switches/buttons carried by the TMU-equipped blasting system element.

In multiple embodiments, a TMU having an externally-generated localization signal reception unit can receive externally-generated localization signals as:
(a) GNSS signals originating from or generated by GNSS satellites, and/or output by a GNSS base station, in which case the TMU includes a GNSS signal reception unit (e.g., a GPS chip); and/or
(b) beacon or geofence signals generated by a set of geofence or beacon units/devices, respectively, disposed at one or more physical sites corresponding to a commercial blasting operation (e.g., a set of mine bench locations), such as RF beacon signals in which case the TMU includes an RF signal reception unit, where such RF signals correspond to or fall within one or more portions of the RF signal communication spectrum (e.g., as defined in accordance with International Telecommunication Union (ITU) RF signal spectrum bands, such as Industrial, Medical, and Scientific (ISM) frequency bands, for instance, electromagnetic signals within at least one of the Extremely Low Frequency (ELF), Super Low Frequency (SLF), Ultra Low Frequency (ULF), Very Low Frequency (VLF), Low Frequency (LF), Medium Frequency (MF), High Frequency (HF), Very High Frequency (VHF), Ultra High Frequency (UHF), Super High Frequency (SHF), and Extremely High Frequency (EHF) bands), and which in some embodiments include WiFi or Bluetooth™ signals.

Depending upon embodiment, environmental, and/or commercial blasting operation details, particular spatial reference location data relative to which the TMU's inertial measurement/navigation unit estimates, approximates, or determines one-dimensional (1D), two-dimensional (2D), and/or three-dimensional (3D) TMU translocation can be based on, correspond to, or be derived or calculated using one or more of:
(a) quasi-absolute, expected near-absolute, expected accurate, or generally/approximately accurate spatial position signals/data provided as, corresponding to, or derived from GNSS signals/data (e.g., high precision, corrected, or medium/low precision GPS signals/data), for instance, which can be established by way of:
   (i) communication of GNSS signals/data received by an external apparatus or device, such as an encoding/programming device, to the TMU-equipped blasting element, for instance, in association with a TMU-equipped blasting element encoding/programming procedure; or
   (ii) in certain embodiments, direct receipt of GNSS signals/data by a GNSS signal reception unit carried by the TMU-equipped blasting element;
      and
(b) non-absolute or relative position signals/data corresponding to at least one spatial reference zero position, location, or point, such as a “relative zero point” or “relative zero” spatial position or location, which can be established by way of:
   (i) communication of proximity-based signals/data corresponding to a set of proximity-based geofence or beacon units/devices (e.g., which can emit wireless signals such as near-field communication (NFC), WiFi, Bluetooth™, other types of wireless communication signals that can be detected within or correlated with a spatial region, position range, or location) to the TMU-equipped blasting element, where the set of proximity-based geofence or beacon units/devices are disposed at one or more particular physical sites corresponding to a commercial blasting operation (e.g., a set of mine bench locations); or
   (ii) the generation of the set of non-absolute or relative position signals/data during a specific procedure or activity/action performed in association with the commercial blasting operation, for instance, by way of an encoding/programming device that communicates such signals/data to the TMU-equipped blasting element during an encoding/programming procedure; or the activation of at least one switch/button carried by the TMU-equipped blasting system element as part of in-field deployment of the TMU-equipped blasting element.

In accordance with multiple embodiments of the present disclosure, an initiation-related device carrying at least one TMU and which is intended for use in a commercial blasting operation can include or be a TMU-equipped initiation device, a TMU-equipped portion of an initiation device, or a TMU-equipped accessory/attachment for an initiation device. The TMU-equipped initiation device, the TMU-equipped initiation device portion, or the TMU-equipped initiation device accessory/attachment, each of which can be referred to as a TMU-equipped initiation-related device, can be configurable or configured for at least some of:
(a) (i) receiving/storing externally-generated localization signals that are correlated with, which correspond to, or which can establish or define a spatial zone/perimeter or geofence; and/or
   (ii) receiving/storing spatial reference location data that establishes or defines a set of spatial reference locations associated with programming/encoding and/or deployment of the TMU-equipped initiation-related device in a commercial blasting operation under consideration;
(b) recurrently estimating/determining, or estimating/determining a likelihood of, whether the TMU-equipped initiation-related device is within or has been translocated beyond or outside of an externally-generated localization signal detection zone, at least one spatial zone/perimeter or geofence (e.g., a 1D, 2D, and/or 3D spatial zone/perimeter or geofence), and/or at least one predetermined or programmably defined spatial position range (e.g., a maximum allowable translocation range or translocation distance threshold) by way of:
   (i) detecting or sensing whether externally-generated localization signals are currently being received or reliably received, or are not being received or reliably received (e.g., have fallen below a minimum acceptable signal strength, level, amplitude, or magnitude threshold, which can be predetermined, selectable, or programmable); and/or
   (ii) recurrently generating TMU positional data, including at one or more times TMU positional data that is correlated with or which corresponds to represents a set of estimated, approximated, or calculated spatial offsets (e.g., at least one net positional offset, and/or a cumulative/accumulated positional offset) of the TMU-equipped initiation-related device relative to the set of spatial reference locations;
(c) selectively generating a set of translocation signals/translocation data (e.g., a translocation alert signal/translocation alert data) and/or an initiation device operational state transition command (e.g., a safe mode, reset, or disable command) in the event that translocation of the TMU-equipped initiation-related device beyond a particular spatial position zone/perimeter/geofence or set of spatial boundaries has occurred, has likely occurred, or has been estimated or determined to have occurred; and possibly
(d) selectively generating/outputting/storing a set of translocation visual indicator signals/data by which a display device can visually or visibly indicate (e.g., by way of optical signals corresponding to the visual or visible optical spectrum) an operational and/or translocation status or state of the TMU-equipped initiation-related device relative to the set of spatial reference locations.

For at least some types of TMU-equipped initiation-related devices, a control unit of a given TMU-equipped initiation-related device and/or another blasting system element with which the TMU-equipped initiation-related device is associated can be configured for interrogating, communicating, establishing, or modifying/adaptively changing the operational mode or state of the TMU-equipped initiation-related device based on or in response to translocation signal/data (e.g., the translocation alert signal/data) and/or a state transition command generated by the TMU. In multiple embodiments, modifying the operational state/mode of the TMU-equipped initiation-related device involves automatically transitioning or switching the TMU-equipped initiation-related device to a safe/standby mode or a reset/disabled/inoperative state in response to the translocation signal/data (e.g., the translocation alert signal/data) or the state transition command, depending upon embodiment details. In specific embodiments, modifying the operational state/mode of the TMU-equipped initiation-related device can additionally or alternatively involve automatically transitioning or switching the TMU-equipped initiation-related device to an on, enabled, ready, or active state (e.g., a fully enabled state), as further detailed below.

In various embodiments, wireless initiation devices are configurable or configured for carrying at least one TMU. A non-limiting representative example of a wireless initiation device that can be configured for carrying a TMU is an Orica™ WebGen™ wireless initiation device (Orica International Private Limited, Singapore). In at some embodiments, a given wireless initiation device carrying a TMU, the TMU is configurable or configured for receiving/storing:
(a) externally-generated localization signals; and/or
(b) spatial reference location data corresponding to one or more spatial reference locations, positions, or sites associated with deployment of the wireless initiation device in a commercial blasting operation, such as (a) a first reference location at which the wireless initiation device is being or was encoded/programmed (e.g., programmed for use in a particular commercial blasting operation), and/or (b) a second reference location at which the wireless initiation device is being or was stored, delivered, installed, or deployed/loaded (e.g., loaded into a borehole) in association with or for carrying out the particular commercial blasting operation.

The TMU can be further configured for processing/analyzing such signals and/or data to estimate, approximate, or determine whether the TMU, and hence a wireless initiation device to which it is coupled, is being or is likely being, or has or has likely been, translocated appropriately (e.g., in an acceptable or expected manner) and/or inappropriately (e.g., in an unacceptable or unexpected manner), for instance, (i) beyond or outside of an externally-generated localization signal reception zone, or beyond or outside of at least one a spatial perimeter/geofence/set of spatial boundaries, and/or (ii) beyond at least one translocation distance threshold corresponding to or along a borehole (e.g., into and subsequently out of a borehole/blasthole, or more than approximately 50 centimeters, or 1 or more meters, out of or toward an opening of a borehole/blasthole following loading of the wireless initiation device into the borehole/blasthole).

In some embodiments, an encoding apparatus/device or encoder used to program or transition a TMU-equipped initiation device from an inactive or disabled state to an active or enabled state (e.g., an enabled state in which the initiation device can respond to commands, such as ARM and FIRE commands) can communicate spatial reference location data (e.g., which represents, is correlated with, corresponds to, approximates, or includes a current encoder spatial location) to the TMU, as further elaborated upon below. Additionally or alternatively, spatial reference location data can be communicated to the TMU by way of signals/data generated as part of an in-field deployment/loading procedure in which the initiation device is deployed/loaded at a particular in-field location (e.g., a particular borehole into which the wireless initiation device is loaded), such as by way of (a) the activation of at least one switch/button carried by the TMU-equipped initiation device; or (b) communication involving a mechanized, automated, or autonomous deployment/loading system, apparatus, or device configured to communicate spatial reference location data (e.g., which represents, is correlated with, corresponds to, approximates, or includes a current deployment/loading apparatus location) to the TMU. Such in-field TMU-equipped initiation device deployment can correspond to or be part of a procedure in which the initiation device is transferred/conveyed to or placed/positioned at a particular in-field location at which initiation is intended to occur, for instance, a borehole loading procedure performed at a particular borehole into which the TMU-equipped initiation device is being loaded either manually, semi-automatically/semi-autonomously, or automatically/autonomously, as further elaborated upon below.

Spatial location(s)/position(s) of the TMU-equipped wireless initiation device relative to externally-generated localization signals and/or the spatial reference location data can be repeatedly or periodically estimated, monitored, tracked, or calculated by way of the TMU. In multiple embodiments, in the event that the TMU determines that the wireless initiation device has been, or likely has been, translocated or displaced beyond a predetermined, selectable, or programmably defined acceptable zone/range or distance (e.g., a maximum allowable distance) relative to or away from (a) the location(s) of one or more geofence signal or beacon signal devices disposed in an environment (e.g., a set of mine bench locations) external to the TMU-equipped wireless initiation device; (b) the first reference location and/or the second reference location, the TMU can responsively generate a translocation signal/translocation data (e.g., a translocation alert signal, and possibly data corresponding thereto) and/or an operational state transition command or instruction by which the TMU-equipped wireless initiation device can be automatically transitioned to a specific operational mode or state (e.g., a safe/standby mode, a reset state, or a disabled state). In several representative embodiments, for a given TMU-equipped wireless initiation device, in response to the translocation signal/data (e.g., the translocation alert signal/data) or a state transition command generated by way of the TMU, the TMU-equipped wireless initiation device can accordingly undergo (e.g., on an automatic basis) an operational state change (e.g., to a safe/standby mode, or a reset/disabled state).

In various embodiments, a TMU includes or is based on an inertial measurement unit (IMU), such as a commercially available IMU chip, and/or semiconductor device circuitry based thereon, associated therewith, or corresponding thereto. A TMU and/or the IMU thereof can include a set of movement sensors that are internal to the IMU, including accelerometers and/or gyroscopes, and possibly a set of magnetometers, in a manner readily understood by individuals having ordinary skill in the relevant art. The IMU may include contain one accelerometer, one gyroscope, and optionally one magnetometer per axis for each of one, two or three of the three orthogonal spatial directions or dimensions or principal axes (i.e., pitch, roll and yaw). The TMU (specifically the processing unit 210 and memory 300) is configured to receive the measurements of spatial displacement(s) from the movement sensors and/or from the IMU, and to evaluate (i.e., calculate, monitor, indicate, estimate, and/or measure) spatial displacement of the wireless initiation device to which the TMU corresponds based on the measurements of spatial displacement(s). Additionally or alternatively, in several embodiments a TMU can include an externally-generated localization signal reception unit, which is configured for receiving electromagnetic and/or MI-based localization signals generated by systems, subsystems, or devices disposed external to the TMU and the wireless initiation device to which the TMU corresponds (e.g., a set of geofence/beacon signal generation units/devices disposed in a commercial blasting environment). The externally-generated localization signal reception unit is configured to detect externally-generated localization signals, and (optionally in association with other elements of the TMU, specifically the TMU processing unit 210 and memory 300) evaluate (i.e., calculate, monitor, indicate, estimate, and/or measure) spatial displacement of the wireless initiation device to which the TMU corresponds based on the externally-generated localization signals. For instance, in such embodiments the TMU can include a GNSS unit configured for receiving GNSS signals (e.g., a commercially available GNSS/GPS chip); an RF signal reception unit configured for receiving RF localization signals (e.g., WiFi or Bluetooth™ beacon signals); and/or an MI signal reception unit configured for receiving MI-based localization signals (e.g., produced by a set of geofence/beacon devices configured for generating MI-based geofence/beacon signals). Depending upon embodiment details, the TMU can be built into a blasting system element such as an initiation device, for instance, as part of the blasting system element's manufacture; or the TMU can be selectively couplable to (including attachable to and/or insertable into) the blasting system element after blasting system element manufacture.

### Aspects of TMU-Equipped Blasting System Element Structure and Function

Aspects of non-limiting representative embodiments of particular TMU-equipped blasting system elements, as well as particular TMU-related or TMU-based blasting system element operational state transitions, are further described in detail hereafter. For purpose of brevity, clarity, and to aid understanding, the description hereafter is primarily directed to TMU-equipped wireless initiation devices, which can be referred to as wireless electronic blasting (WEB) devices, such as Orica™ WebGen™ wireless initiation devices, that are configurable or configured for carrying TMUs. Also for purpose of brevity and clarity, in the following description TMUs corresponding to the TMU-equipped wireless initiation devices are configured for selectively generating, outputting, or communicating operational state transition commands that such types of wireless initiation devices can process. Notwithstanding the foregoing, embodiments in accordance with the present disclosure are not limited to initiation devices, and TMUs corresponding to initiation devices or other blasting system elements are not limited to generating, outputting, or communicating operational state transition commands.

### Aspects of Particular TMU-Enabled Initiation Devices

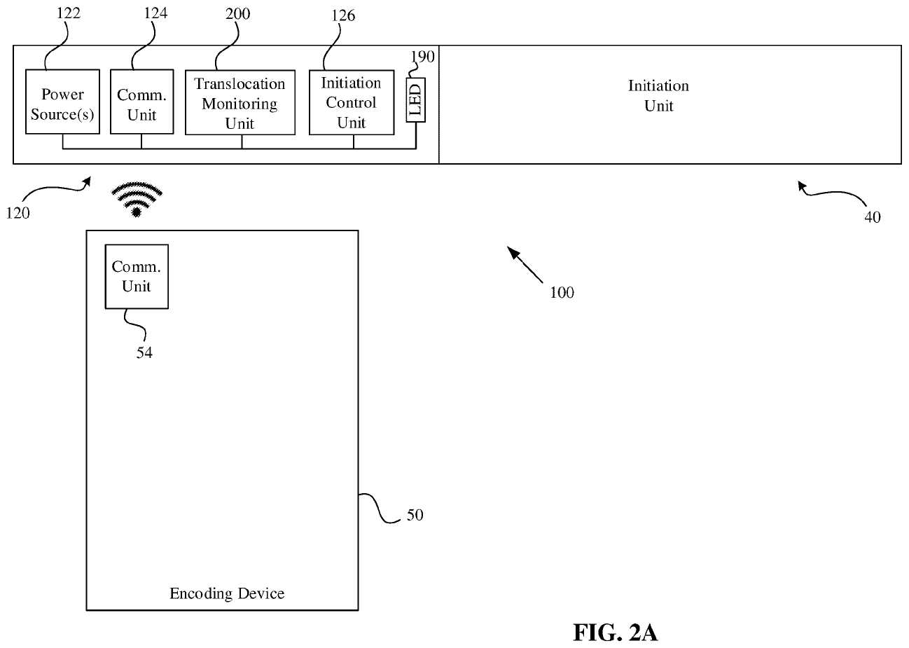

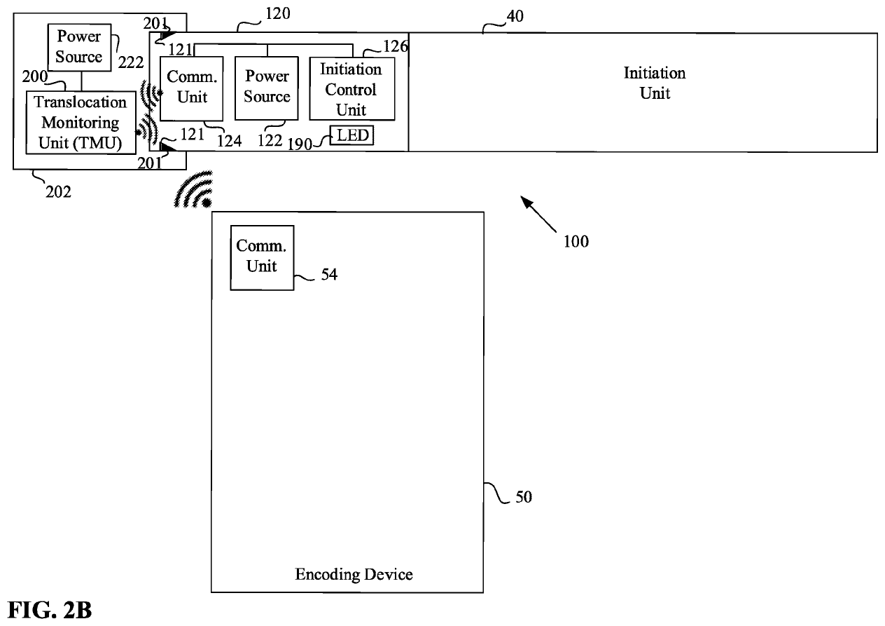

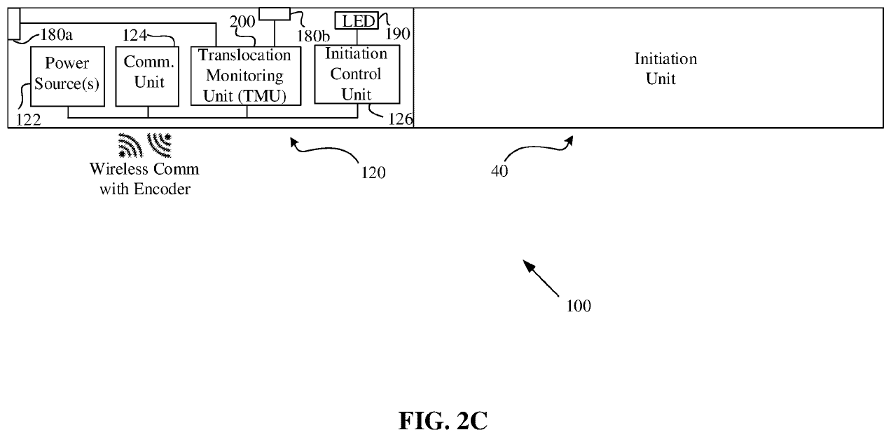

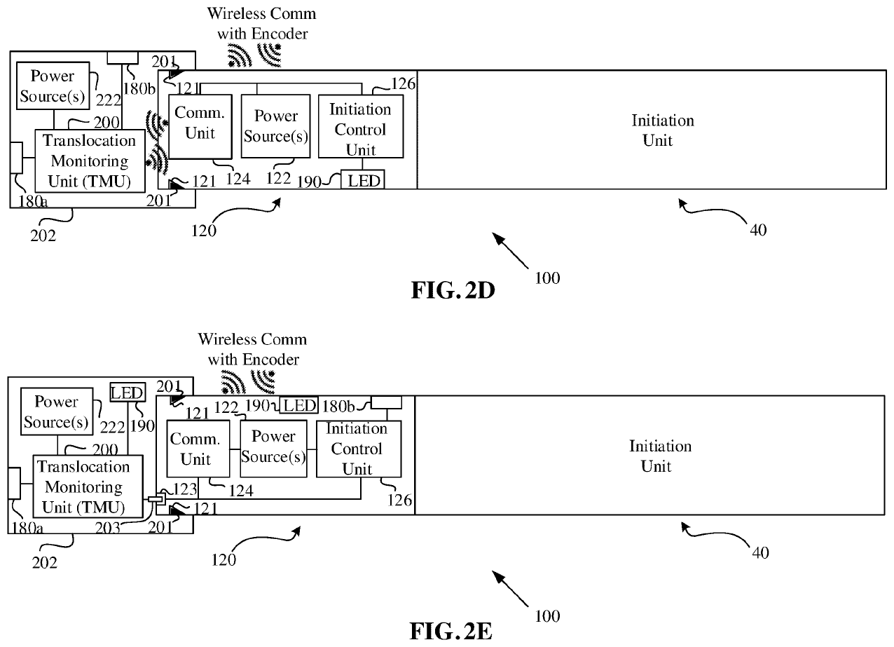

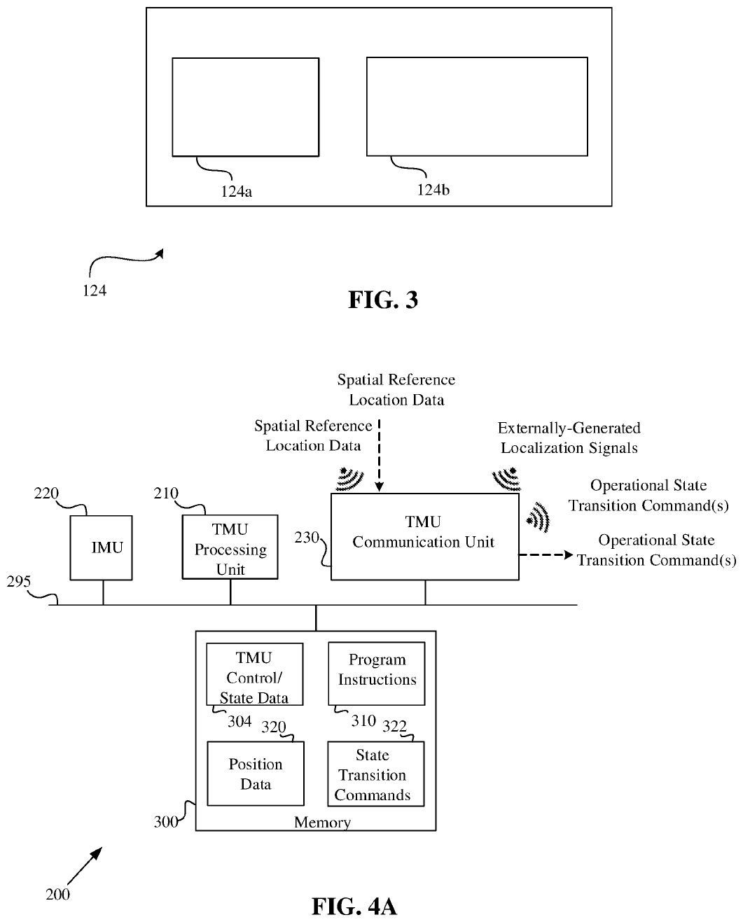

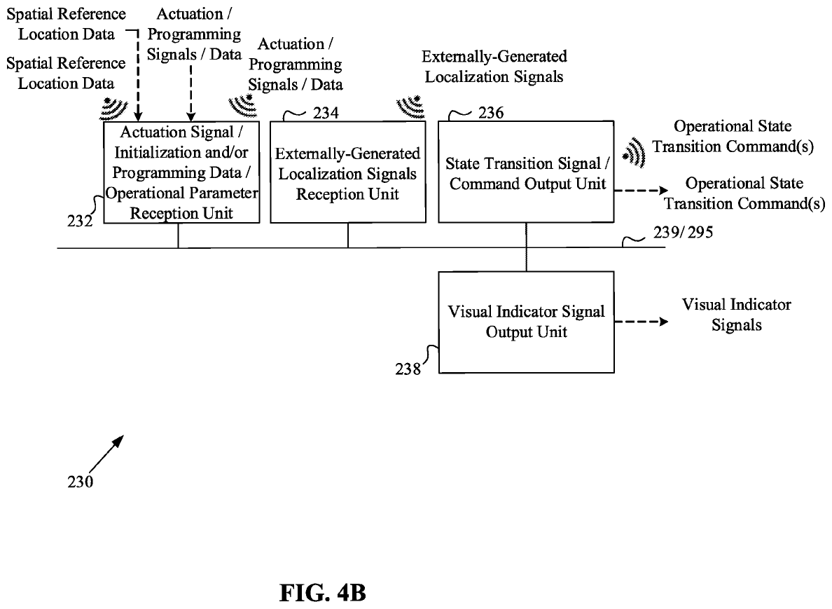

FIGS. 2A-4B show aspects of TMU-equipped WEB devices 100, which can be referred to hereafter as TMU-WEB devices 100, in accordance with several embodiments of the present disclosure. More particularly: FIGS. 2A-2E are block diagrams showing aspects of TMU-WEB devices 100 in accordance with particular non-limiting representative embodiments of the present disclosure; FIGS. 2A-2B additionally show non-limiting representative aspects of communication between particular embodiments of TMU-WEB devices 100a,b and external encoding/programming devices or encoders 50; FIG. 3 is a block diagram of a TMU-WEB device communication unit 124 in accordance with an embodiment of the present disclosure; and FIGS. 4A-4B are a block diagrams illustrating aspects of TMUs 200 in accordance with a number of non-limiting representative embodiments of the present disclosure.

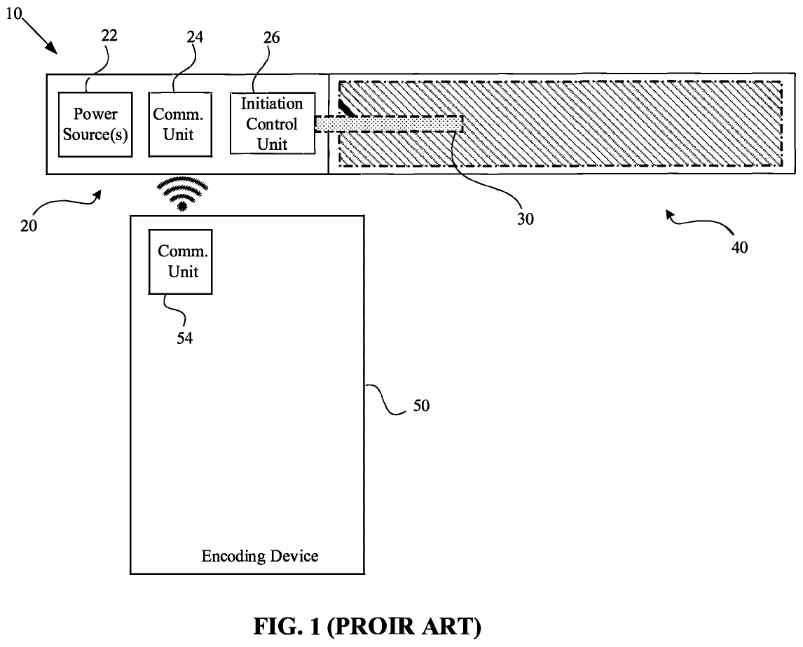

As shown in FIGS. 2A-2E, a TMU-WEB device 100 includes a communication and control (CC) portion, module, or unit 120 that is couplable (e.g., selectively couplable) or coupled to an initiation portion, module, or unit 40, for instance, an initiation unit 40 that is configured for initiating, and optionally carries, an explosive composition (not shown), e.g., in a manner analogous, essentially identical, or identical to that described above with reference to FIG. 1. In various embodiments, the TMU-WEB device 100 also includes an initiation element such as an electronic detonator (not shown) that is couplable or coupled to the CC unit 120, and which is insertable or inserted into or carried within the initiation unit 40 for initiating/detonating an explosive composition corresponding to the initiation unit 40, for instance, in a manner analogous, essentially identical, or identical to that described above with reference to FIG. 1, as individuals having ordinary skill in the relevant art will also readily comprehend.

The CC unit 120 includes a first power unit/set of power sources 122 (e.g., including one or more batteries and/or capacitors, and typically associated power management circuitry) coupled to each of a TMU-WEB device communication unit 124, an initiation control unit 126, and a TMU 200. The CC unit 120 can include a set of signal/data transfer pathways or lines (e.g., a set of buses) that couple or link the elements therein, in a manner readily understood by individuals having ordinary skill in the relevant art.

The TMU-WEB device's initiation control unit 126 can include integrated circuitry configurable or configured for operating in a manner analogous or essentially identical to the initiation control unit 26 described above with reference to FIG. 1A, such that the TMU-WEB device's initiation control unit 126 can programmably and precisely control the manner(s) in which the initiation unit 40 is explosively initiated, as individuals having ordinary skill in the relevant art will also readily comprehend.

The TMU-WEB device communication unit 124 can include integrated circuitry configurable or configured for one-way or two-way wireless communication, e.g., involving RF, magnetic induction (MI), and/or other types of wireless communication signals. In various embodiments, the TMU-WEB device communication unit 124 is configured for wireless communication with each of (a) an encoder communication unit 54 by way of first wireless communication signals, such as first RF signals (e.g., NFC/RF signals) and/or optical signals; and (b) a set of antennas 95, 96 associated with a blast control system 90, such as by way of second wireless communication signals that can include MI signals (e.g., quasi-static MI signals) and/or second RF signals (e.g., where the second wireless communication signals can be through-the-earth (TTE) signals). As shown in FIG. 3, the TMU-WEB device communication unit 124 can thus include or be defined as having a first communication unit 124a configured for a first type of wireless communication (e.g., NFC communication) by way of the first wireless communication signals; and a second communication unit 124b configured for a second type of wireless communication (e.g., MI and/or RF communication, which can include TTE communication) by way of the second wireless communication signals.

In view of the foregoing, by way of the TMU-WEB device communication unit 124 and the initiation control unit 126 in the CC unit 120 in various embodiments is configurable or configured for (a) receiving instructions/commands from and exchanging data with an external encoding/programming device or encoder 50 having an encoder communication unit 54 (e.g., which is configurable or configured for wireless communication by way of the first communication signals); and (b) processing and implementing or carrying out such instructions/commands. Instructions/commands and data received from the encoder 50 can be directed to establishing or modifying the TMU-WEB device's operational status or state. The CC unit 120 is further configured for receiving instructions/commands and possibly receiving data from or exchanging data with a set of antennas 95, 96 associated with a remote blast control system 90, including instructions/commands that enable or which lead to triggering explosive initiation of the TMU-WEB device's initiation unit 40, such that an explosive blast (e.g., the detonation of a column of explosive material(s) in a blasthole) occurs in accordance with a specific commercial blasting operation with which the TMU-WEB device 100 is associated.

The TMU 200 includes integrated circuitry configurable or configured for estimating, monitoring, tracking, approximating, or calculating TMU location/position and/or translocation or spatial displacement in accordance with an embodiment of the present disclosure. As shown in FIGS. 2A and 2C, the TMU 200 can be incorporated in the wireless initiation device, i.e., provided as a built-in portion of the CC unit 20, e.g., in association with a TMU-WEB device manufacturing process, in a manner that individuals having ordinary skill in the relevant art will clearly understand. In such embodiments, the TMU 200 can be coupled to the first power unit/set of power sources 122, the TMU-WEB communication unit 124, and the initiation control unit 126. Alternatively, as shown in FIGS. 2B, 2D, and 2E, the TMU 200 can be carried by or contained in a structure that is separate (e.g., initially separate), distinct, or separable from the CC unit 120 and the initiation unit 40, for instance, a TMU housing module 202 that can be selectively structurally coupled, attached, or fastened (e.g., securely attached or fastened) to a portion of the CC unit 120 and/or the initiation unit 40. For purpose of brevity and simplicity, in the description that follows the TMU housing module 202 is couplable to the CC unit 120. In several embodiments, the TMU housing module 202 is a snap-on/screw-on module that can be provided as an accessory to an initiation device (e.g., a wireless initiation device) that otherwise lacks a built-in TMU 200, for instance, a wireless initiation device 10 such as that shown in FIG. 1A. The TMU housing module 202 and the CC unit 120 can carry one or more types of counterpart coupling, attachment, or fastening structures, such as counterpart male and female snap-fit engagement structures 201, 121 in a manner shown in FIGS. 2B and 2D-2E, as readily understood by individuals having ordinary skill in the relevant art.

Depending upon embodiment details, the TMU 200 within the TMU housing module 202 can be configured for wire-based and/or wireless communication with the TMU-WEB device communication unit 124 and/or the initiation control unit 126. For instance, in several embodiments such as shown in FIG. 2D, the TMU 200 within the TMU housing module 202 can be configured for one-way or two-way wireless communication with the TMU-WEB device communication unit 124, such as by way of the aforementioned first RF signals (e.g., NFC RF signals), and/or by way of other signals such as MI signals. In such embodiments, the TMU 200 can generate and output instructions/commands in a manner analogous or essentially identical to an encoder 50, in a manner that individuals having ordinary skill in the relevant art will clearly comprehend. As indicated or shown in FIG. 2E, the TMU within the TMU housing module 202 can additionally or alternatively be configured for wire-based communication with the TMU-WEB device communication unit 124 and/or the initiation control unit 126. In such embodiments, the TMU housing module 202 and the CC unit 120 can carry complementary electrical contact structures 203, 123 (e.g., counterpart male-female electrical contact structures) configured for establishing positive and negative electrical signaling pathways between the TMU 200 and the TMU-WEB device communication unit 124 and/or the initiation control unit 126 upon mating engagement of the TMU housing unit 202 with the CC unit 120 and corresponding electrical contact structure mating engagement to facilitate or enable such wire-based communication, in a manner that individuals having ordinary skill in the relevant art will also readily comprehend. In addition to carrying a TMU 200, in several embodiments the TMU housing module 202 carries its own power unit/power source(s), such as a second set of power sources 222 (e.g., having one or more batteries and/or capacitors) and associated power management circuitry by which the TMU 200 can be powered.

Depending upon embodiment details, the TMU 200 can be turned on/powered up or transitioned from an inactive or quiescent/sleep/standby mode or state to an active state by way of (a) coupling of the TMU housing unit 202 to the CC unit 120 (and thus to the wireless initiation device); (b) communication (e.g., wireless communication) with an encoder 50; and/or (c) activation (e.g., manual activation) of a set of switches/buttons 180. Furthermore, in some embodiments the switch(es)/button(s) 180 can be activated to provide or establish spatial reference location data in the TMU 200, for instance, in a manner indicated above. In a number of embodiments, the generation of spatial reference data defining a relative zero spatial reference location or point corresponding to a current TMU spatial location can occur by way of the activation of each of a first switch/button 180a and a second switch/button 180b, for instance, in a sequenced or concurrent/simultaneous manner. Depending upon embodiment details, the first and second switches/buttons 180a,b can each be carried by the TMU housing module 202, as shown in FIG. 2D; or the first switch/button 180a can be carried by the TMU housing module 202, and the second switch/button can be carried by another portion of the TMU-WEB device 100, such as the CC unit 120 as shown in FIG. 2E.

As indicated above, a TMU-WEB device 100 can carry at least one visual indicator, which in several embodiments includes or is a set of LEDs 190. Depending upon embodiment details, the TMU 200 and/or the initiation control unit 126 can be configurable or configured for selectively activating one or more LEDs 190 to indicate a current operational status, mode, or state of the TMU-WEB device 100 in a manner correlated with or based upon a current or most-recent estimated, determined, or calculated TMU spatial location relative to an acceptable spatial position zone/range or distance or a set of spatial boundaries (e.g., spatial perimeter/geofence boundaries), which can be defined with respect to (a) the reception of externally-generated localization signals, and/or (b) the spatial reference location data.

Further to the foregoing, the CC unit 120 can optionally include one or more additional elements coupled to the initiation control unit 124, such as a set of sensing devices or sensors (e.g., light, temperature, vibration, pressure, and/or chemical species sensors) configured for sensing one or more characteristics or properties of an environment in which the CC unit 120 resides. Analogously, the TMU housing module 202 can optionally include one or more additional elements, such as a set of sensing devices or sensors (e.g., chemical species sensors) configured for sensing one or more characteristics or properties of an environment in which the TMU housing module 202 resides.

FIG. 4A is a block diagram of a TMU 200 in accordance with particular embodiments of the present disclosure. The TMU 200 includes an electronic processing unit (e.g., a microprocessor or microcontroller) in the form of a TMU processing unit 210; an IMU 220; and a TMU memory 300. In various embodiments, the TMU 200 also includes a TMU communication unit 230 configured for receiving incoming signals/data, and outputting or issuing outbound signals/data. Depending upon embodiment details, one or more portions of the TMU processing unit 210 and/or the TMU communication unit 230 can be separate from the IMU 220; and/or one or more portions of the TMU processing unit 210 and/or the TMU communication unit 230 can be incorporated within or provided by the IMU 220, depending upon structural aspects and functional capabilities of the IMU 220. The TMU processing unit 210, the IMU 220, and the TMU communication unit 230 cooperatively function in a manner that facilitates or enables translocation-based TMU-WEB device control processes, procedures, and/or operations, such as further detailed below. Each element of the TMU 200 can be coupled to a set of signal/data communication pathways 295 such as a set of signal/data buses, in a manner readily understood by individuals having ordinary skill in the relevant art.

The TMU communication unit 230 includes integrated circuitry configurable or configured for wireless and/or wire-based communication with elements or devices that reside external to the TMU, depending upon embodiment details, and which can communicate or transfer signals and/or data to elements within the TMU 200. For instance, in embodiments such as shown in FIGS. 2A, 2C, and 2E, the TMU communication unit 230 is configured for wire-based communication with the TMU-WEB device communication unit 124 and/or the initiation control unit 126; whereas in embodiments such as shown in FIGS. 2B and 2D, the TMU communication unit 230 is configured for wireless communication with the TMU-WEB device communication unit 124. Depending upon embodiment details, the TMU communication unit 230 can:
(a) receive from devices or elements external to the TMU 200 (i) initialization signals/data, operational signals/data, and instructions/commands directed to activating, enabling/programming, and/or controlling aspects of TMU operation, which the TMU processing unit 210 can process; (ii) externally-generated localization signals, which the TMU processing unit 210 can process; (iii) spatial reference location data (e.g., establishing a spatial zero reference location, position, or point) for the TMU 200; (iv) data defining a minimum acceptable externally-generated localization signal strength, level, amplitude, or magnitude that the TMU processing unit 210 can utilize to determine whether or not the TMU 200 is within an appropriate, acceptable, or safe zone/perimeter or distance away from, or at an appropriate, acceptable, or safe location/position relative to, a set of geofence/beacon signal generation units/devices external to the TMU-WEB device 100; and/or (v) a set of maximum allowable spatial displacements, translocations, or distances and/or a set of geofence boundaries for the TMU 200 relative to the TMU's spatial reference location data (e.g., a maximum allowable net spatial displacement and/or a maximum cumulative spatial displacement along one or more spatial directions, or 2D or 3D geofence boundaries defined with respect to the spatial reference location data, which the TMU 200 must remain within to avoid the generation of a TMU-WEB device operational state transition command); and
(b) output TMU-WEB device operational state transition commands and TMU mode or state/status information to devices or elements external to the TMU 200.

FIG. 4B is a block diagram showing aspects of a TMU communication unit 230 in accordance with particular non-limiting representative embodiments of the present disclosure. The TMU communication unit 230 includes a set of wireless signal communication units. Depending upon embodiment details, the TMU communication unit 230 includes at least some of:
(a) a first signal reception unit 232 configured for receiving by way of wire-based and/or wireless signal communication one or more of actuation/initialization signals/data, TMU operational parameter signals/data, and TMU programming signals/data, and possibly configured for transmitting or communicating certain signals/data such as acknowledgment/query signals;
(b) a second signal reception unit 234 configured for wirelessly receiving externally-generated localization signals, such as one or more of GNSS signals, RF localization signals, and MI-based localization signals;
(c) a state transition command/signal output unit 236 configured for outputting TMU-WEB device operational state transition commands/signals; and
(d) a visual indicator signal output unit 238 configured for outputting visual indicator signals for and to a set of visual indicator devices for visibly or visually indicating a current state of the TMU-WEB device 100 (e.g., whether the TMU-WEB device is enabled, or operating in a safe/partially disabled mode).

Each element of the TMU communication unit 230 can be coupled to one or more sets of signal/data communication pathways 239, 295 such as one or more sets of signal/data buses, in a manner readily understood by individuals having ordinary skill in the relevant art.

In various embodiments, the first signal reception unit 232 includes a first RF signal communication unit, for instance, an NFC, WiFi, and/or Bluetooth signal communication unit, providing at least one RF signal receiver. The first RF signal communication unit can be coupled to or include a set of RF signal communication antennas (e.g., a first set of RF signal communication antennas), in a manner understood by individuals having ordinary skill in the relevant art. The first signal reception unit 232 can be implemented by way of conventional or off-the-shelf circuitry or components, in a manner that individuals having ordinary skill in the art will also comprehend.

Depending upon embodiment details, the second signal reception unit 234 can include a GNSS signal reception unit, such as a GNSS chip or chipset; a second RF signal communication unit having at least one RF signal receiver, for instance, a WiFi, Bluetooth, or other type of signal communication unit, which can be coupled to or include a set of RF signal communication antennas (e.g., a second set of RF signal communication antennas), in a manner understood by individuals having ordinary skill in the relevant art; and/or an MI-based signal reception unit, which can include a set of MI signal communication antennas, such as one or more coil antennas, as individuals having ordinary skill in the relevant art will also understand. The second signal reception unit 234 can be implemented by way of conventional or off-the-shelf circuitry or components, which individuals having ordinary skill in the art will comprehend.

In several embodiments, the state transition command/signal output unit 236 includes a third RF signal communication unit providing an RF transmitter, which can be coupled to or include a set of RF signal communication antennas (e.g., a third set of RF signal communication antennas); or an MI signal communication unit providing an MI signal transmitter, which can be coupled to or include a set of MI signal communication antennas (e.g., a second set of MI signal communication antennas). The state transition command/signal output unit 236 can be implemented by way of conventional or off-the-shelf circuitry or components, in a manner that individuals having ordinary skill in the art will also comprehend.

Individuals having ordinary skill in the relevant art will understand that depending upon embodiment details, in some embodiments a set of signal communication antennas (e.g., RF signal communication antennas, or MI signal communication antennas) can be shared between different wireless signal communication units that operate using the same type of wireless communication signals. For instance, in certain embodiments a set of RF signal communication antennas can be shared between the first, second, and/or third RF signal communication units, depending upon which RF signal communication unit needs to utilize the set of RF signal communication antennas at a particular time, possibly in accordance with a utilization priority protocol or scheme. Individuals having ordinary skill in the relevant art will also understand that a wireless signal receiver of a particular wireless signal communication unit and a wireless signal transmitter of another wireless signal communication unit can be implemented by way of a wireless signal transceiver in certain embodiments.

The visual indicator signal output unit 238 can include a set of signal drivers/buffers configured for outputting visual indicator signals (e.g., which activate or energize a set of visual indicators such as a set of LEDs 190), in a manner that individuals having ordinary skill in the relevant art will understand.

The TMU's memory 300 includes integrated circuitry configurable or configured for providing a TMU control/state memory 304 for storing current TMU operational/control parameters or data and current TMU mode/state data; a program instruction memory 310 for storing program instruction sets executable by the processing unit 210 for controlling aspects of TMU operation; and a location/position data memory 320 for storing TMU-related location/position data. Depending upon embodiment details, the TMU control/state memory 304 and/or the location/position data memory 320 can store at least some of: (a) a minimum externally-generated localization signal strength, level, amplitude, or magnitude indicating or correlated with expected reliable reception of externally-generated localization signals; (b) spatial reference location data for the TMU 200; (c) a set of allowable (e.g., maximum allowable) spatial displacement/translocation threshold distance data for the TMU 200, which can be approximately correlated with at least one spatial zone/region/periphery or geofence within which the TMU-WEB device 100 can be or remain in a normal or fully-enabled operational state, and a spatial zone/region/periphery or geofence outside of which the TMU-WEB device 100 should be transitioned to a safe/reset mode or disabled state. The TMU location/position data memory 320 can additionally store (c) data estimating, indicating, or calculating the TMU's approximate location/position relative to most-recently received externally-generated localization signals and/or the TMU's spatial reference location data; and (d) possibly current/most-recent and in certain embodiments at least some historical TMU location/position data correlated with or corresponding to TMU spatial locations/positions or displacements at particular times or over time, for instance, relative to a set of previously received externally-generated localization signals and/or the spatial reference location data. The TMU's spatial reference location data, the set of maximum allowable spatial displacement/translocation data, and estimated or calculated TMU location/position data can be date and time stamped, in a manner understood by individuals having ordinary skill in the relevant art.

The memory 300 further includes an operational state transition command memory 322 for storing a set of operational state transition commands generated by the TMU processing unit 210, where each operational state transition command is directed to modifying or updating an operational mode or state of the TMU-WEB device 100 corresponding to the TMU 200. Each operational state transition command can include a time and date stamp. A given operational state transition command within the state transition command memory 322 can be associated with particular TMU location/position data stored in the position data memory 320, for instance, by way of a digital code or identifier, a reference to a memory location/address, and/or a flag.

The TMU processing unit 210 and the IMU 220 include integrated circuitry configurable or configured for tracking, estimating, detecting, monitoring, measuring, and/or determining a current spatial zone/region/location/position and/or displacement of the TMU relative to externally-generated localization signals that have been received, and/or the spatial reference location data, for instance, in accordance with program instructions stored in the program instruction memory 310 and which are executable or executed by the TMU processing unit 210. The TMU processing unit 210 can correspond to or include or be a microcontroller, microprocessor, or state machine, in a manner readily understood by individuals having ordinary skill in the relevant art. The IMU 220 can include a set of accelerometers and/or a set of gyroscopes, possibly a set of magnetometers, and other associated electronic circuitry (e.g., an application specific integrated circuit (ASIC)) that facilitates or enables one or more of sensed accelerometer and/or gyroscope signal conversion/conditioning; IMU interfacing/data communication with other TMU elements; IMU reset/initialization/testing; and selective or programmable IMU operational mode setup/configuration (e.g., by way of data communication involving the TMU processing unit 210). In a representative embodiment, the IMU 220 is similar or analogous to, includes, is based on, or is a commercially available IMU chip, such as a BMI088 IMU chip produced by Bosch-Sensortec (Bosch-Sensortec GmbH, Reutlingen, Germany), which includes a microelectromechanical system (MEMS) providing a triaxial accelerometer and a triaxial gyroscope.

In multiple embodiments (e.g., embodiments which include an externally-generated localization signal reception unit 234), the TMU processing unit 210 is configurable or configured for initiating/controlling, managing/monitoring, or performing recurrent TMU processes, procedures, and/or operations, including at least some of:
(1) determining whether most-recently received externally-generated localization signals have a signal strength, level, amplitude, or magnitude that meets or exceeds a minimum acceptable/threshold signal strength, level, amplitude, or magnitude;
(2) if so, determining whether most-recently received externally-generated localization signals indicate that the TMU 200 (and hence the TMU-WEB device 100 to which the TMU 200 corresponds) likely resides within a first, first allowable/acceptable, preferred, or expected most-safe spatial zone/region/location or position range, perimeter, or geofence, or within a first translocation distance threshold associated with or corresponding to the external localization source(s) that generated or communicated these externally-generated localization signals;
(3) determining (a) whether the TMU 200 (and hence TMU-WEB device 100 to which the TMU 200 corresponds) has or likely has been translocated or moved beyond the first, first allowable/acceptable, preferred, or expected most-safe spatial zone/region/location or position range, perimeter, or geofence, or past the first translocation distance threshold (e.g., in response to the externally generated localization signals falling below the minimum acceptable/threshold signal strength, level, amplitude, or magnitude); and possibly (b) whether translocation data generated relative to the set of spatial reference locations in association with or by way of the IMU 220 indicates that the TMU 200 resides (i) within a second, second allowable/acceptable, or expected generally-safe spatial zone/region/location or position range, perimeter, or geofence, or within a second translocation distance threshold; or (ii) beyond the second, second allowable/acceptable, or expected generally-safe spatial zone/region/location or position range, perimeter, or geofence, or past the second translocation distance threshold;
(4) determining whether the TMU 200 (and hence the TMU-WEB device 100 to which the TMU 200 corresponds) (a) is likely being loaded into a borehole during a borehole loading procedure, in association with or based on estimated/calculated translocation or movement of the TMU 200 (e.g., relative to the spatial reference location data) along a set of spatial directions corresponding to the spatial orientation of the borehole and across a spatial distance corresponding to a borehole location at which the TMU-WEB device 100 is approximately likely or expected/intended to into reside in the borehole; and/or (b) has been loaded into the borehole/blasthole, and has subsequently likely moved (i) out of the borehole/blasthole, or (ii) more than an acceptable/allowable/expected safe distance toward the opening of the borehole/blasthole after having been loaded into the borehole/blasthole;
(5) depending upon embodiment details, selectively generating or issuing an operational state transition command directed to transitioning the operational state of the TMU-WEB device 100 to a safe/standby mode or a reset/disabled state based on (a) a current or most-recent estimated or likely location of the TMU 200 with respect to (i) the first, first allowable/acceptable, preferred, or expected most-safe spatial zone/region/location or position range, perimeter, or geofence, or the first translocation distance threshold; and/or (ii) the second, second allowable/acceptable, or expected generally-safe spatial zone/region/location or position range, perimeter, or geofence, or the second translocation distance threshold; and/or (b) whether the TMU 200 has likely moved (i) out of the borehole/blasthole, or (ii) more than an acceptable/allowable/expected safe distance toward the opening of the borehole/blasthole after having been loaded into the borehole/blasthole; and possibly
(6) generating or triggering/controlling the generation of a visual indicator signal or command that corresponds to the current intended operational state of the TMU-WEB device 100.

In various embodiments, with respect to generating or managing the generation of translocation data relative to the set of spatial reference locations, the TMU processing unit 210 is configurable or configured for recurrent processes, procedures, and/or operations including at least some of: accessing, acquiring, retrieving, or receiving (e.g., from a set of first-in first-out (FIFO) buffers) accelerometer and/or gyroscope data generated by the IMU 220 (e.g., on a near-real time, periodic, or requested basis), and recurrently or periodically determining, calculating, or estimating (e.g., on a near-real time, periodic, or requested basis) a current TMU spatial position or displacement (e.g., net displacement and/or a cumulative, aggregate, or accumulated spatial displacement) relative to the spatial reference location data, such as a current distance or radius away from a spatial zero reference location or point, based on the accelerometer and/or gyroscope data. As indicated above, the TMU processing unit 210 is further configurable or configured for selectively generating an operational state transition command in the event that the current calculated or estimated net TMU spatial displacement or position relative to the spatial reference location data exceeds a maximum allowable spatial displacement or falls outside of a particular spatial zone/region/location or position range or set of geofence boundaries established for the TMU 200.

After an operational state transition command has been generated, the TMU processing unit 210 can communicate with the TMU communication unit 230 for outputting or issuing the operational state transition command to the TMU-WEB device communication unit 124 and/or the initiation control unit 126, such that the TMU-WEB device 100 to which the TMU 200 corresponds or belongs can accordingly undergo an operational state transition (e.g., to a safe/standby mode or a reset/disabled/inoperative state).

### Aspects of TMU-WEB Device Programming, In-Field Deployment, and Operation

Aspects of non-limiting representative manners of activating/programming, deploying, and operating/controlling TMU-WEB devices 100 in certain types of commercial blasting operations are further described in detail below. Individuals having ordinary skill in the relevant art will understand that the description that follows extends to additional/other types of commercial blasting operations.

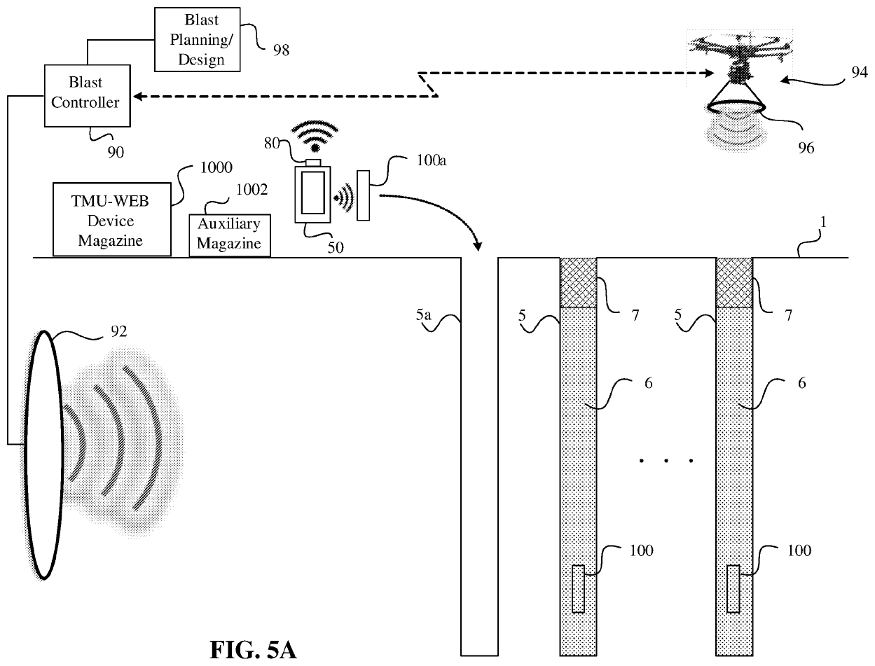

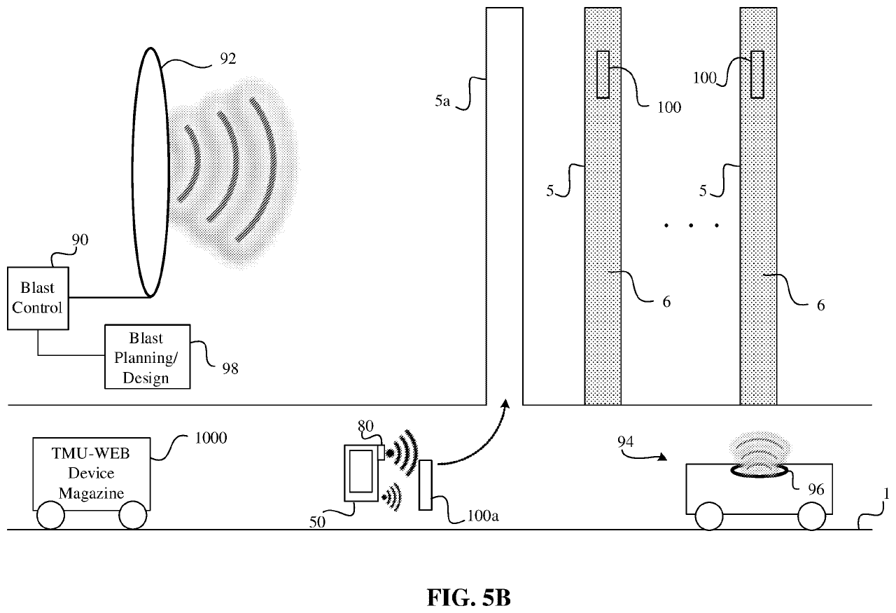

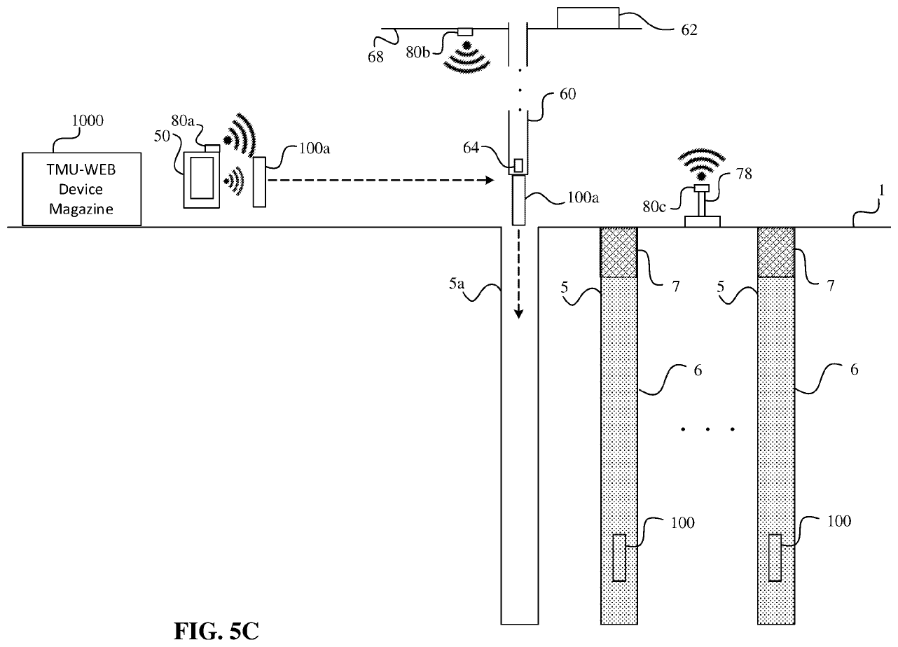

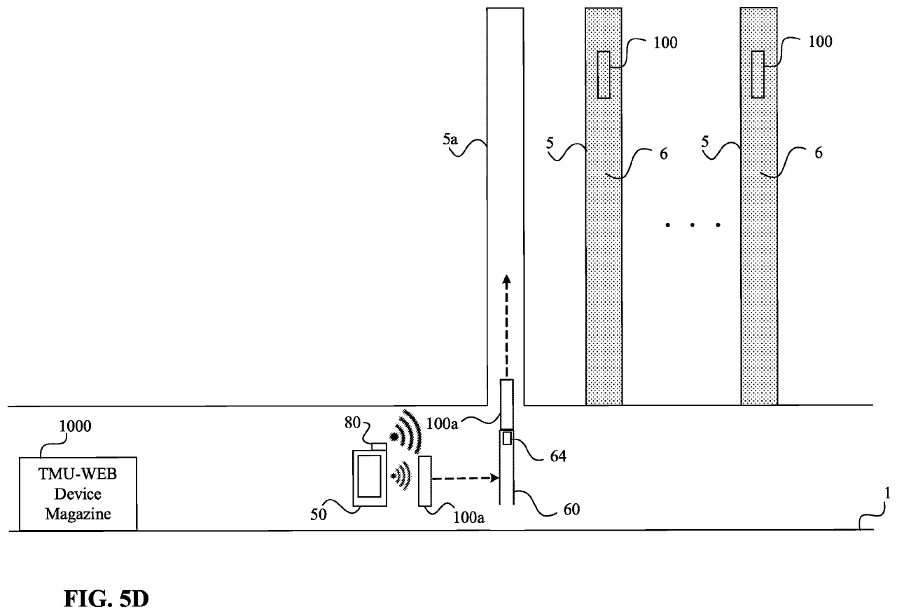

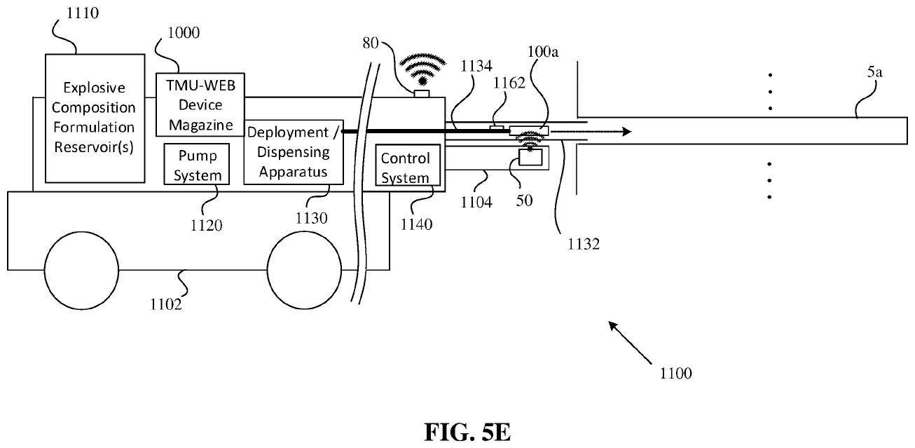

FIGS. 5A-5E show representative aspects of in-field/on-site TMU-WEB device activation/programming and deployment in boreholes/blastholes 5 in association with carrying out a particular commercial blasting operation, for instance, a commercial surface or underground blasting operation (e.g., performed in a mining, quarrying, or civil tunneling environment).

As indicated in FIGS. 5A and 5B, a group of TMU-WEB devices 100 that are deployable or to be deployed in-field (e.g., in an open cut/surface mining or a geophysical/seismic exploration environment such as shown in FIG. 5A, or an underground mining environment such as shown in FIG. 5B) can be stored in a TMU-WEB device magazine 1000, for instance, which has been transported to a particular in-field zone or location by way of a vehicle. The TMU-WEB devices 100 can be configured for one-way or two-way wireless communication with one or more types of remote blast control equipment 90, 92 such as by way of one or more antennas 94, 96 configurable or configured for communicating commands to the TMU-WEB devices 100 and possibly receiving signals/data from the TMU-WEB devices 100 in a manner readily understood by individuals having ordinary skill in the relevant art.

In various embodiments, an authorized worker can obtain a given TMU-WEB device 100a from the TMU-WEB magazine 1000. If the given TMU-WEB device 100a in the TMU-WEB magazine 1000 does not include a built-in TMU 200 or a TMU housing module 202 is not already coupled or attached to the given TMU-WEB device 100a, an auxiliary, associated, or secondary magazine 1002 in which TMU housing modules 202 (e.g., as described above) reside can also be transported to the in-field zone or location, and the authorized worker can couple or attach a given TMU housing module 202 to the given TMU-WEB device 100a.

The authorized worker can use a portable/hand-held encoder 50 to program the given TMU-WEB device 100a by way of an encoding procedure. During the encoding procedure, the encoder 50 can communicate (a) blast timing information corresponding to an initiation time delay for the given TMU-WEB device 100a (e.g., corresponding to a precise time delay that this TMU-WEB device 100a is programmed to wait before triggering explosive initiation of the initiation unit 40 after the TMU-WEB device 100a receives a FIRE command); and possibly or optionally (b) a group identifier (GID) that defines a particular group of TMU-WEB devices 100 to which the given TMU-WEB device 100a belongs.

In some embodiments, the encoder 50 can additionally communicate with or send signals (e.g., wireless signals) to the TMU 200 corresponding to the given TMU-WEB device 100a, for instance, to at least some of: (i) power up, wake up, or transition the TMU 200 to a responsive, active, or fully active state; (ii) output or communicate externally-generated localization signals in proximity to, in the vicinity of, or toward or to the TMU 200 by way of a geofence/beacon unit 80 (e.g., which outputs geofence/beacon signals, and which in at least some embodiments can include or be a conventional/commercially-available WiFi or Bluetooth™ beacon unit/device) carried by, couplable/attachable to, or built into the encoder 50; (iii) transfer to the TMU 200 a minimum acceptable signal strength, level, amplitude, or magnitude threshold corresponding to reliable detection of externally-generated localization signals; and/or spatial reference location data correlated with or corresponding to a current geospatial location of the encoder 50 (e.g., at which the encoding procedure occurs) and defining a spatial zero reference location or point for the TMU 200; and (iv) transfer to the TMU 200 data establishing for the TMU 200, and hence for the given TMU-WEB device 100a that carries the TMU 200, at least one maximum allowable displacement distance (e.g., a maximum allowable net displacement distance, and/or a maximum allowable cumulative, aggregated, or accumulated spatial displacement) and/or a set of geofence boundaries defined with respect to the spatial reference location data. Depending upon embodiment and/or situational/environmental details, the maximum allowable net or cumulative displacement distance or the set of geofence boundaries can respectively define at least one maximum net or cumulative distance, corresponding to at least one spatial direction or axis, away from the spatial zero reference location or point that the TMU 200 can travel without TMU generation or issuance of a TMU-WEB device operational state transition command. The maximum allowable net displacement distance or the set of geofence boundaries can additionally or alternatively define a maximum radius measured from the spatial zero reference location or point to which the TMU 200 can travel without triggering the generation of issuance of an operational state transition command.

In at least some embodiments, a TMU 200 can be pre-programmed (e.g., prior to an encoding procedure performed upon the TMU-WEB device 100 that carries the TMU 200) with default, initial, or expected data, such as maximum allowable displacement data defining a default, initial, or expected maximum allowable displacement distance (which can correspond to or be specified as a physical distance or radius measure or value) relative to a spatial zero reference location for the TMU 200; and/or default, initial, or expected geofence boundary data defining a default, initial, or expected set of geofence boundaries relative to a TMU spatial zero reference location. Additionally or alternatively, the maximum allowable displacement data and/or the geofence boundary data associated with a set of TMU-WEB devices 100 and/or a particular commercial blasting operation can be specified or initially specified in a blast plan generated by a remote blast planning/design system 98, and corresponding blast plan data can be transferred (e.g., by way of wireless data transfer) from the blast planning/design system 98 to one or more encoders 50 and communicated to the set of TMU-WEB devices 100 prior to or in association with loading the set of TMU-WEB devices 100 into the set of boreholes 5 under consideration.

Individuals having ordinary skill in the relevant art will understand that once a conventional initiation device has been encoded by way of a conventional encoding procedure, the conventional initiation device can process and carry out commands including, for instance, WAKE, ARM, and FIRE commands. With respect to a conventional wireless initiation device, after its encoding, as long as the conventional initiation device is within signal communication range of an antenna 92, 96 associated with remote blasting equipment 90, 94, the conventional wireless initiation device can be triggered to cause explosive initiation of the explosive composition(s) carried by its initiation unit 40, even if the conventional wireless initiation device has been transported or displaced a significant distance (e.g., potentially several or even many hundreds of meters) away from its encoding location or the blasthole 5 in which it is intended to reside.

In several embodiments in accordance with the present disclosure, any given TMU-WEB device 100a is not fully enablable/enabled or fully activatable/activated and is restricted or prevented from processing and carrying out one or more commands that can lead to or result in the triggering of explosive initiation of its initiation unit 40 (e.g., at least a FIRE command, or each of an ARM command and a FIRE command) until (a) the TMU-WEB device 100a has been encoded (e.g., in a manner such as set forth above); (b) the TMU 200 corresponding to this TMU-WEB device 100a has been activated; and at least one of (c) its TMU 200 has confirmed successful receipt and/or storage of the spatial reference location data and the maximum allowable displacement distance or the set of geofence boundaries provided to the TMU 200 by way of the encoder 50; (d) the TMU 200 has begun monitoring TMU/TMU-WEB device translocation or displacement relative to the spatial reference location data; possibly (e) the TMU 200 has successfully received or confirmed successful receipt of externally-generated localization signals; and further possibly (f) the TMU 200 has subsequently ceased receiving or reliably receiving externally-generated localization signals and the TMU processing unit 210 has determined or confirmed that the TMU-WEB device 100 has been loaded into a borehole (e.g., in a manner set forth above). In some embodiments, a translocation-enhanced encoding procedure encompasses or satisfies the conditions set forth in (a) through (d) or (a) through (e) above, and each given TMU-WEB device 100 is not fully activated or fully operational (e.g., is prevented from becoming fully activated or fully operational, such as by way of the execution of program instruction sets by a processing unit of the encoder 50) until the translocation-enhanced encoding procedure is complete. In a number of embodiments, a translocation-enhanced encoding procedure plus a translocation-enhanced loading procedure directed to loading the TMU-WEB device 100 into a borehole 5 encompass (a) through (f) above, and each given TMU-WEB device 100 is not fully activated or fully operational (e.g., is prevented from becoming fully activated or fully operational, for instance, such that it cannot carry out at least a FIRE command, or an ARM command followed by a FIRE command) until the translocation enhanced encoding procedure as well as the translocation-enhanced loading procedure are complete.

In certain embodiments, once condition (a) above is complete, the TMU-WEB device 100a can activate one or more visual indicators such as LEDs 190 to indicate that initial TMU-WEB device encoding has occurred. Once conditions (b) through (d) or (b) through (e) have been satisfied, the TMU 200 or the TMU-WEB device CC unit 120 can activate one or more additional visual indicators such as LEDs 190 to indicate that net TMU/TMU-WEB device translocation monitoring has been initiated.

Further to the above, after the TMU 200 corresponding to the given TMU-WEB device 100 has been activated and has received or stored the minimum acceptable externally-generated localization signal strength, level, amplitude or magnitude threshold, spatial reference location data, and maximum allowable net displacement distance data or geofence boundary data from the encoder 50, the TMU processing unit 210 can begin recurrent or periodic monitoring of the spatial location/position and/or displacement of the TMU 200 relative to received externally-generated localization signals and/or the spatial reference location data (e.g., which includes or defines a spatial zero reference location or point for the TMU 200). The TMU 200 can also generate or issue a signal that can activate one or more visual indicators such as LEDs 190 to indicate (e.g., by way of a flashing light of having a first color) that the TMU 200 is actively monitoring the TMU-WEB device's spatial location relative to the spatial zero reference location.

As long as the TMU 200 continues to receive or reliably receive externally-generated localization signals, or remains within a particular set of spatial zones/regions/locations or position ranges, perimeters, or geofences or set of geofence boundaries, or has been translocated less than a particular maximum translocation distance threshold, the TMU 200 avoids the generation or issuance of a TMU-WEB device operational state transition command that will cause the given TMU-WEB device 100a to transition to a safe/standby mode or a reset/disabled/inoperative state in which this TMU-WEB device 100a becomes unresponsive to or incapable of carrying out at least some commands received from the remote blast control equipment 90, including ARM and FIRE commands. In the event that the TMU-WEB device 100a is moved or resides beyond a particular or specific spatial zone/region/location or position range, perimeter, or geofence/set of geofence boundaries, or the displacement of the TMU-WEB device 100a away from the spatial zero reference location exceeds the maximum allowable displacement distance, the TMU 200 issues an operational state transition command to cause this TMU WEB device 100a to undergo an operating mode or state transition such as set forth herein.

In association with issuance of the operational state transition command, the TMU-WEB device's CC unit 120 can activate one or more visual indicators such as LEDs 190 to visually indicate (e.g., by way of a flashing light of a second color) that TMU-WEB device 100a is in a safe/standby mode or a reset/disabled/inoperative state and is no longer responsive to commands that can lead to or cause explosive initiation of the initiation unit 40, for instance, unless this TMU-WEB device 100a once again successfully undergoes another translocation-enhanced encoding procedure or translocation enhanced encoding and loading procedure.

Once the given TMU-WEB device 100a has been encoded/programmed and its corresponding TMU 200 has stored (a) the minimum externally-generated localization signal strength, level, amplitude, or magnitude threshold, (b) spatial reference location data, and (c) the maximum allowable displacement distance data or relevant geofence data, the TMU-WEB device 100a can be loaded into a particular borehole 5a, for instance, in association with the loading of one or more explosive compositions 6 and possibly stemming materials 7 into the borehole as part of a borehole loading procedure. Explosive composition loading can occur by way of a mechanized, automated, or autonomous platform or vehicle configured for carrying and dispensing explosive compositions into boreholes 5, for instance, a vehicle conventionally referred to as a Mobile Manufacturing Unit (MMU) (e.g., which can be similar or analogous to, correspond to, or be based on a commercially available Orica BM-7 MMU), in a manner readily understood by individuals having ordinary skill in the relevant art.

As indicated in FIG. 5C, in some embodiments multiple external localization signal sources 80a-c such as multiple geofence/beacon units, can be present in a commercial blasting environment such as a mine bench at which TMU-WEB devices 100 are being encoded and loaded into boreholes 5. For instance, in addition or as an alternative to the external localization signal source 80a carried by the encoder 50, a loading system, apparatus, or device 60 (e.g., which can be a portion of an MMU) can include a platform, frame, frame member, or arm structure 68 to which another external localization signal source 80b, such as another geofence/beacon unit, is carried (coupled or mounted); and/or one or more ground-based platform structures (e.g., tripods) 78, each carrying an external localization signal source 80c such as yet another geofence/beacon unit, can be present. In the representative embodiment shown in FIG. 5C, the encoder 50 can carry a first geofence/beacon unit 80a; a frame member 68 coupled to the loading system, apparatus, or device 60 can carry a second geofence/beacon unit 80b; and a platform structure 78 can carry a third geofence/beacon unit 80c.

The TMU 200 of a given TMU-WEB device 100a can be configurable or configured for receiving or detecting externally-generated localization signals from one or more or each of such external localization signal sources 80a-c. In certain embodiments, the TMU 200 can be configurable or configured for receiving externally-generated localization signals from each of such external localization signal sources 80a-c, and possibly specifically or uniquely identifying each external localization signal source 80a-c as the origin of particular externally-generated localization signals the TMU 200 has received. Moreover, in a number of embodiments, the TMU 200 can estimate or determine its geospatial position or coordinates relative to three or more external localization signal source 80a-c by way of triangulation or trilateration, in a manner that individuals having ordinary skill in the relevant art will comprehend.

For purpose of simplicity and brevity in the description hereafter, translocation reference data can be defined to include spatial reference location data corresponding to or defining a spatial zero reference location or point, and/or one or each of maximum allowable net displacement distance data and geofence boundary data.

In some embodiments in which at least some aspects of TMU-WEB device configuration and/or operation/functionality are established/finally established or modified/adjusted/updated/expanded/extended in association with or during a loading procedure directed to loading a given TMU-WEB device 100a into a particular borehole 5a (e.g., by way of wireless communication directed to this TMU-WEB device 100a), as indicated above such a loading procedure can be referred to as a translocation-enhanced loading procedure (e.g., in a manner similar or analogous to the translocation-enhanced encoding procedure).

In embodiments such as shown in FIGS. 5C and 5D, a given TMU-WEB device 100a can have certain aspects of its operational/functional capabilities established, further established, or fully-enabled; have accumulated translocation/movement data cleared/reset/zeroed; have at least some translocation reference data (e.g., at least a spatial zero reference location) communicated thereto or established/confirmed therein; and/or be activated to begin TMU-WEB device translocation monitoring, in a manner that is separate or separated from the TMU-WEB device's encoding procedure, for instance, (a) after TMU-WEB device encoding has occurred by way of an encoder 50, and (b) shortly or immediately prior to or as part (e.g., during an initial or final phase) of loading this TMU-WEB device 100a into a particular borehole 5a, for instance, proximate or adjacent to or at a borehole loading site at which loading of this TMU-WEB device 100a into the particular borehole 5a is to occur or is occurring as part of a borehole loading procedure.

Depending upon embodiment details, (i) a loading system, apparatus, or device 60 (e.g., an element accessory associated with or a portion of a movable platform or a vehicle such as an MMU; or a portion of or attachment to an elongate tube; or a portion of an explosives composition delivery hose) configured for selectively holding or handling TMU-WEB devices 100 and having a communication unit 64 associated therewith or couplable/coupled thereto and configured for signal/data communication (e.g., wireless data communication, such as RF and/or MI wireless signal communication) with the TMU-WEB device 100a (e.g., including communication with its TMU 200) to be loaded into the borehole 5a can interact or communicate with the TMU-WEB device 100a in association with loading the TMU-WEB device 100a into the borehole 5a. The communication unit 64 can include or be, for instance, a wireless signal (e.g., RF and/or MI signal) communication unit that is carried near, proximate to, or at a terminal portion of a loading cable, shaft, tube, or hose that is associated with or which forms a portion of the loading system, apparatus, or device 60, and which is used for conveying the TMU-WEB device 100a into the borehole 5a.

For instance, the loading system, apparatus, or device 60 can (i) activate/configure/reset the TMU-WEB device's TMU 200 if not already active/configured/reset, and/or can communicate (e.g., wirelessly) at least some signals/commands/data to one or more portions of the TMU-WEB device 100a (e.g., possibly translocation reference data, such as at least a spatial zero reference location) just before or as the TMU-WEB device 100a is loaded into its intended borehole 5a; (ii) the loading system, apparatus, or device 60 can actuate or activate one or more switches 180 carried by the given TMU-WEB device 100a (e.g., in association with coupling or engagement of the given TMU-WEB device 100a with the loading system, apparatus, or device 60) to clear/reset/zero accumulated translocation/movement values (data) generated and stored by way of the IMU (e.g., in the TMU 200), establish the TMU-WEB device's spatial zero reference location, and/or initiate TMU monitoring of net TMU-WEB device translocation (by the estimation or measurement of spatial displacement), shortly or just before or as the TMU-WEB device 100a is loaded into this borehole 5a; and/or (iii) an authorized worker can activate one or more switches 180 carried by the TMU-WEB device 100a for one or more of such purposes just before or as this TMU-WEB device 100 is loaded into its borehole 5a.

Further in view of the foregoing, in some embodiments a TMU-WEB device 100a is not fully enabled or fully operational/activated and is restricted from processing and carrying out particular commands that can lead to or result in the triggering of explosive initiation of its initiation unit 40 (e.g., at least a FIRE command, or an ARM command followed by a FIRE command) until each of an encoding procedure (e.g., a translocation-enhanced encoding procedure) has occurred, and a translocation-enhanced loading procedure is occurring or has occurred. For instance, (a) in association with or upon completion of an encoding procedure (e.g., a translocation-enhanced encoding procedure), the TMU-WEB device 100a can be partially enabled/not fully enabled, such that it can process and carry out only a limited number or restricted subset of commands, or only certain commands, for instance, commands by which the TMU-WEB device can be further programmed (e.g., to (re) set initiation timing and/or (re) program TMU-WEB device GID data), but the TMU-WEB device 100a remains restricted or disabled with respect to processing and carrying out a FIRE command, or an ARM command and a FIRE command; and (b) in association with or only as part of/upon completion of a subsequent translocation-enhanced loading procedure, the TMU-WEB device 100a can be or has been transitioned to a fully enabled or fully activated operational state, in which it can process and carry out a FIRE command, or an ARM command followed by a FIRE command.

More particularly, in a number of embodiments, in association with or as part of TMU-WEB device 100a loading in to the borehole 5a by the loading system, apparatus, or device 60 (e.g., once the loading system, apparatus, or device 60 has positioned the TMU-WEB device 100 near or at a target, minimum, or predetermined distance into the borehole 5a, and/or shortly or immediately prior to the loading system, apparatus, or device 60 releasing the TMU-WEB device 100 in association with TMU-WEB device 100 deployment in the borehole 5a), the loading system, apparatus, or device 60 can act upon or interact/communicate with one or more portions of the TMU-WEB device 100 to transition the TMU-WEB device 100 from a partially-enabled operational state, such as described above in which the TMU-WEB device 100a is unable to or is prevented from processing and carrying out at least some commands including a FIRE command, to a fully-enabled operational state in which the TMU-WEB device 100 can process and carry out a FIRE command (e.g., by way of processing and carrying out an ARM command, and a FIRE command, possibly in association with processing and carrying out a WAKE command prior thereto). For instance, the communication unit 64 of the loading system, apparatus, or device 60 can issue one or more signals/commands to the TMU-WEB device's CC unit 120 and/or the TMU 200 to transition the TMU-WEB device 100a to its fully-operational state. Communication between the communication unit 64 and the TMU 200 can trigger or result in further communication between the TMU 200 and the TMU-WEB device's CC unit 120.

In still other embodiments, a loading system, apparatus, or device 60 can carry, include, or be coupled to an encoder 50 (e.g., such that the communication unit 64 is associated with or part of such an encoder 50), and the TMU-WEB device 100a can be encoded and transitioned to a fully-enabled/fully-functional operational state (e.g., able to respond to WAKE, ARM, and FIRE commands) by the encoder 50 associated with the loading system, apparatus, or device 60 as part of a combined encoding plus loading operation by which the TMU-WEB device 100a is encoded as well as loaded into the borehole 5a.

For instance, in association with or as part of a borehole loading procedure directed to a particular borehole 5a, the TMU-WEB device 100a to be loaded into the borehole 5a can be encoded to a partially enabled state (e.g., programmed with a blast ID code and/or a GID code) by an encoder 50 carried by the loading system, apparatus, or device 60 (e.g., which resides outside of the borehole 5a). While in the partially-enabled state, the TMU-WEB device 100a cannot process and/or carry out a FIRE command, or ARM and FIRE commands. Once the loading system, apparatus, or device 60 has transferred the TMU-WEB device 100a into or along at least a (selected) minimum, predetermined/selectable/programmable, or significant fraction of the extent of the borehole 5a toward and possibly at least approximately to a borehole location at which the TMU-WEB device 100a is intended to be disposed or released by the loading system, apparatus, or device 60, the communication unit 64 outputs or issues a set of signals/commands to the TMU-WEB device 100a to transition the TMU-WEB device 100a to a fully-enabled state in which it can process and carry out a FIRE command, or ARM and FIRE commands. Depending upon embodiment details, the communication unit 64 can be coupled to the encoder 50 and/or a loading control unit or controller 62 of the loading system, apparatus, or device 60, which can generate the signal(s)/command(s) directed to transitioning the TMU-WEB device 100a to its fully-enabled state, i.e., to transition the state to a fully enabled or fully activated operational state, in which it can process and carry out a FIRE command, or an ARM command followed by a FIRE command.

In a number of embodiments, TMU-WEB devices 100 can be encoded as well as loaded into boreholes 5 (e.g., in association or along with explosive composition loading into boreholes) by way of unified or integrated automated or autonomous equipment.

FIG. 5E is a schematic illustration showing portions of an automated or autonomous TMU-WEB device handling, encoding, and borehole loading system or apparatus 1100 in accordance with an embodiment of the present disclosure. In an embodiment, the system or apparatus 1100 includes a mobile platform 1102 (e.g., which is couplable/coupled to or includes a prime mover) that carries a set of explosive composition formulation reservoirs 1110; a TMU-WEB device magazine 1000; a deployment/dispensing apparatus 1130 configured for receiving TMU-WEB devices from the magazine 1000, selectively or programmably displacing TMU-WEB devices 100 toward boreholes 5, and loading TMU-WEB devices 100 into boreholes 5 by way of an arm structure 1134 that is associated with, includes, or is a hollow tube or hose 1134 through which one or more explosive composition formulations can be pumped into boreholes 5 by way of a pump system 1120; a support structure 1104 that carries an encoder 50; and a control system 1140 configured for controlling the retrieval, encoding, and loading of TMU-WEB devices 100 into boreholes 5 and loading explosive composition formulations into boreholes 5. The system or apparatus 1100 can additionally carry or include an external localization signal source 80, such as a geofence/beacon signal unit, which can but need not be coupled to or carried by the encoder 50 (e.g., the external localization signal source 80 can be mounted to a portion of the mobile platform 1102). The control system 1140 can be configured for signal/data communication (e.g., wireless communication) with other systems/apparatuses, such as a blast planning/design system 98 that can provide the encoder 50 with data corresponding to a blast plan for a set of boreholes 5 under consideration.

After a given TMU-WEB device 100a has been retrieved from the magazine 1000 (and possibly assembled, if the given TMU-WEB device 100a is a multi-piece unit), the deployment/dispensing apparatus can position this TMU-WEB device 100a proximate or adjacent to the encoder 50 (e.g., by way of pushing the given TMU-WEB device 100a) such that this TMU-WEB device 100a is within signal/data communication distance of the encoder 50. The control system 1140 can issue an instruction or command to the encoder 50 in response to which the encoder 50 can (a) encode this TMU-WEB device 100a, for instance, as set forth above; and possibly (b) transfer a set of signals/commands and/or translocation reference data (e.g., defining at least a spatial zero reference location) to the TMU-WEB device 100a, such that the TMU-WEB device's TMU 200 is activated and the TMU 200 begins monitoring the net displacement of this TMU-WEB device 100a relative to its spatial zero reference location. After this TMU-WEB device 100a has been encoded, it can be loaded into its intended borehole 5a.

In some embodiments, the tube/hose 1134 can be coupled to or carry a communication unit 1162 in a manner analogous to that shown in FIG. 5C for the loading system, apparatus, or device 60. The communication unit 1162 can be configured for wireless communication (e.g., RF signal and/or MI signal communication) with the TMU-WEB device 100a, and can be coupled to the encoder 50 and/or the control system 1140. In certain embodiments, the encoder 50 can program or encode the TMU-WEB device 100a to a partially-enabled operational state (e.g., in which the TMU-WEB device 100a cannot carry out at least a FIRE command); and once the tube/hose 1134 has positioned the TMU-WEB device 100a approximately to or beyond a particular or certain distance into the borehole 5a (e.g., a target or final location along the borehole 5a at which the TMU-WEB device 100a is intended to reside for carrying out a particular commercial blasting operation), the encoder 50 and/or the control system 60 can generate a set of signals/commands directed to transitioning the TMU-WEB device 100a to a fully-enabled state. The communication unit 1162 can correspondingly wirelessly communicate with one or more portions of the TMU-WEB device 100a (e.g., its CC unit 120 and/or TMU 200), such that the TMU-WEB device 100a transitions to the fully-enabled state, i.e., generate signals/commands to transition the state to a fully enabled or fully activated operational state, in which it can process and carry out a FIRE command, or an ARM command followed by a FIRE command. In particular embodiments, the TMU 200 need only be activated/fully activated for translocation monitoring once the TMU-WEB device 100a enters or is disposed in the borehole 5A, for instance, in association with (e.g., shortly prior to or during) transitioning the TMU-WEB device 100 to its fully-enabled state. After the TMU-WEB device 100a has been positioned at or approximately at an intended position along the borehole 5a, and after communication between the communication unit 1162 and the TMU-WEB device 100a is no longer required, the tube/hose 1134 is withdrawn from the borehole 5.

In the event that the TMU 200 carried by the TMU-WEB device 100a under consideration determines that the TMU 200, and hence the TMU-WEB device 100a to which it corresponds, has been translocated beyond a maximum cumulative or net spatial displacement distance or outside of a set of geofence boundaries defined for the TMU-WEB device 100a, or has been released at or translocated to a target or intended deployment location along the borehole 5 and subsequently translocated out of the borehole 5 or nearly/very nearly out of the borehole 5 (e.g., to within less than 0.1-1.0 meters away from the borehole opening or collar), the TMU 200 can issue an operational state transition command in a manner set forth above, in response to which the TMU-WEB device 100a can transition to a safe/standby mode or a reset/disabled/inoperative state in which this TMU-WEB device 100a cannot successfully process or carry out ARM and FIRE commands, for instance, in a manner as set forth above.

### Additional Aspects of Translocation Monitoring and TMU-WEB Device Control

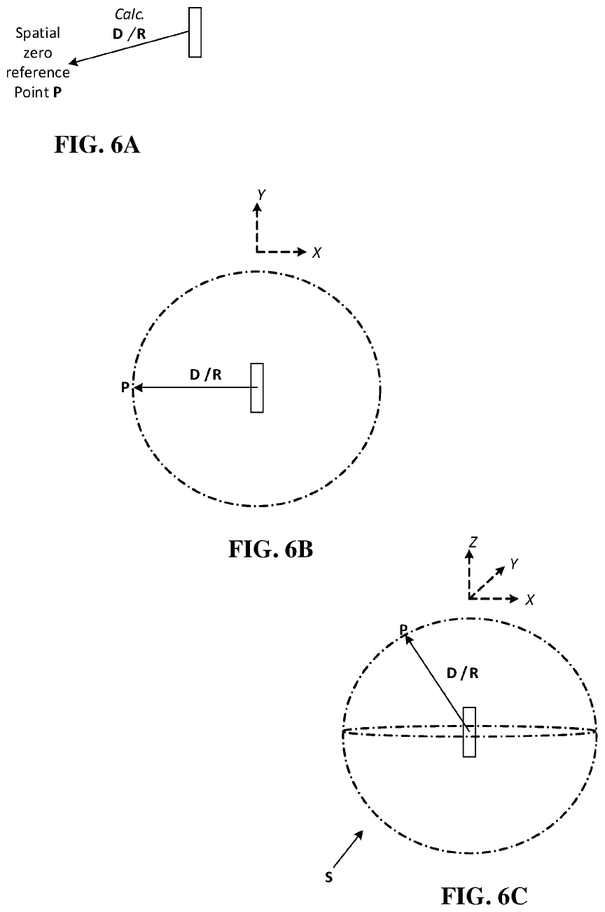

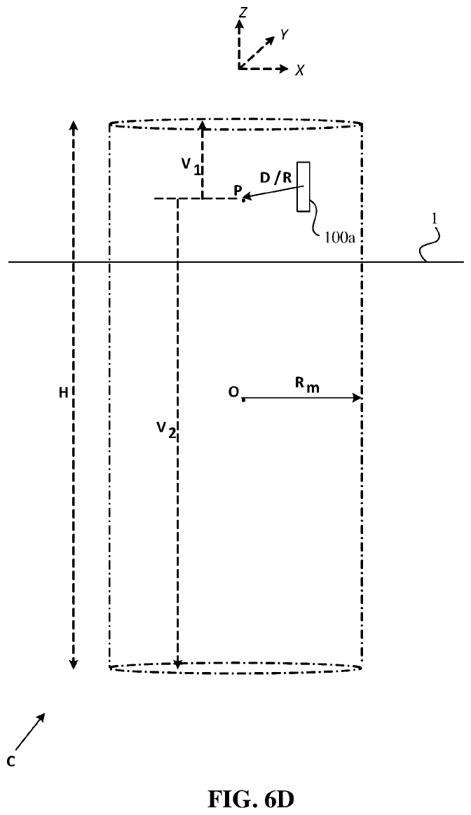

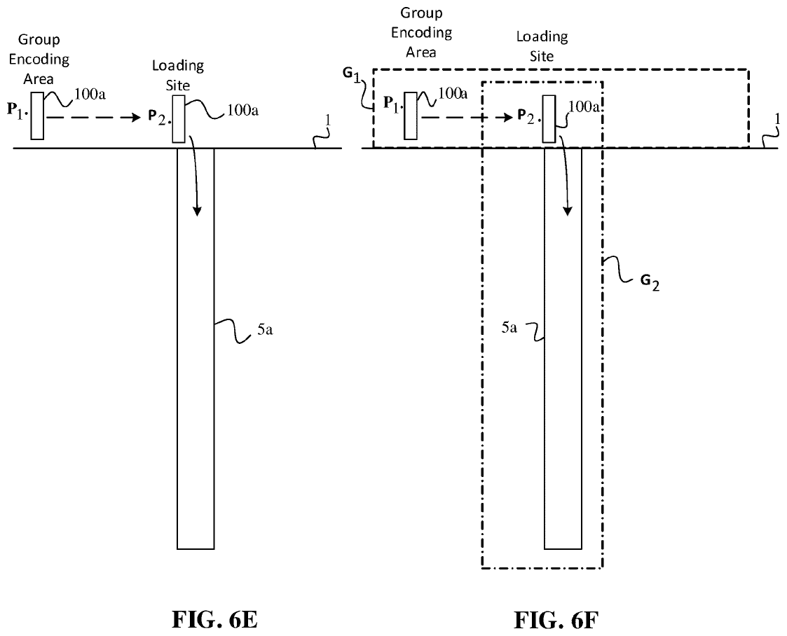

FIGS. 6A-6D show certain additional non-limiting representative aspects of estimating, monitoring, determining, or calculating TMU-WEB device position or displacement/translocation (e.g., net displacement/translocation or a radius) relative to a set of geofence boundaries, and/or away from a set of spatial zero reference locations or points relative to a set of maximum allowable displacement/translocation distances (a maximum net displacement/translocation distance or a maximum radius). In the description that immediately follows, TMU-WEB device displacement/translocation with respect to a maximum allowable net displacement/translocation distance is considered; however, embodiments in accordance with the present disclosure can additionally or alternatively monitor and calculate, evaluate, estimate, or measure TMU-WEB device displacement/translocation with respect to a maximum allowable cumulative displacement/translocation distance, for instance, in a manner analogous to that described below.

As shown in FIG. 6A, in several embodiments a TMU 200 is configurable or configured for recurrently estimating, approximating, determining, or calculating a current or most-recent distance D or radius R between the TMU 200 (or correspondingly the TMU-WEB device 100 carrying the TMU 200) and a spatial zero reference location or point P stored in the TMU 200. The TMU processing unit 210 can recurrently/repeatedly or periodically (a) retrieve or receive current/most-recent/recent and possibly relatively-recent or recent-past accelerometer and/or gyroscope data generated by the IMU 220; (b) calculate an estimated or approximate current or most-recent TMU displacement beyond a most-recently calculated cumulative TMU displacement away from the spatial zero reference point P; (c) calculate an estimated or approximate magnitude of a current or most-recent net distance or radius, such as the magnitude of a 2D or 3D vector distance or radius, of the TMU 200 away from the spatial zero reference point P. If the magnitude of this estimated or approximate net distance or radius is less than or equal to the maximum net displacement/translocation distance established for or stored in the TMU 200, then the TMU 200 avoids the generation of an operational state transition command for the TMU-WEB device 100 to which it corresponds. Otherwise, the TMU 200 generates an operational state transition command directed to the TMU-WEB device 100, for instance, in a manner set forth above.

As indicated in FIG. 6B, depending upon embodiment details, the TMU 200 can calculate an estimated or approximate magnitude of a 2D vector distance or radius between the TMU 200 and its spatial zero reference point P; or as indicated in FIG. 6C, the TMU 200 can calculate an estimated or approximate magnitude of a 3D vector distance or radius between the TMU 200 and its spatial zero reference point P.

In some embodiments, the maximum allowable displacement data or the geofence boundary data define a single uniformly symmetric spatial region that is centered about the spatial zero reference point P, such as a spherical spatial region S shown in FIG. 6C, within which the given TMU-WEB device 100a must remain in order to avoid the generation or issuance of an operational state transition command by its corresponding TMU 200. The spatial zero reference point P thus corresponds to or defines the geometric origin of the spherical spatial region S. In such embodiments, the maximum allowable net displacement distance or the set of geofence boundaries can include or be a single value that corresponds to or defines a particular number of meters away from the spatial zero reference point P in any spatial direction (or all spatial directions), such as 5-10 meters, 20 meters, 25 meters, 35 meters, 50 meters, 75 meters, 100 meters, 150 meters, 200 meters, 250 meters, 300 meters, or possibly more depending upon a commercial blasting operation and/or environment under consideration. Such geofence boundaries can be referred to as a spherical geofence S.

In further or other embodiments, and/or depending upon a commercial mining operation and/or environment under consideration, the maximum allowable displacement distance data and/or the geofence boundary data can correspond to or define a spatial region in which the spatial zero reference point is not at the geometric origin of the spatial region. For instance, as shown in FIG. 6D, the geofence data can specify or define a cylindrical spatial region corresponding to a cylinder (e.g., a right cylinder) C having a geometric origin O, an overall height H, and a maximum radius Rₘ away from each of the origin O and the spatial zero reference point P. The geofence boundary data further define a first vertical distance V₁ relative to the spatial zero reference point P that establishes a first/upward vertical distance between the spatial reference point P and a first planar surface of the cylinder C, such as the geometric top of the cylinder C; and a second vertical distance V₂ relative to the spatial reference point P that establishes a second/downward vertical distance between the spatial zero reference point P and an opposite second planar surface of the cylinder C, such as the geometric bottom of the cylinder C.

For a given TMU-WEB device 100a, its TMU 200 can monitor/measure net translocation of the TMU-WEB device 100a away from the spatial zero reference point P with respect to each of Rₘ, V₁, and V₂. As long as the TMU-WEB device 100a remains within the borders or boundaries corresponding to or defined by region C, the TMU 200 avoids the generation or issuance of an operational state transition command such as described herein. Otherwise, the TMU 200 generates or issues an operational state transition command, in response to which the TMU-WEB device 100a transitions or switches to safe/standby mode or a reset/disabled/inoperative state.

As indicated above, in some embodiments a TMU 200 can additionally or alternatively monitor/measure cumulative TMU-WEB device 100 translocation relative to a cumulative, aggregate, or accumulated maximum displacement distance. For instance, the TMU 200 can generate or issue an operational state transition command in the event that the TMU-WEB device 100 to which it corresponds has been displaced by a cumulative distance that exceeds the cumulative maximum displacement distance relative to the TMU's spatial zero reference point P. Further additionally or alternatively, depending upon embodiment details, the TMU 200 can monitor/measure the TMU-WEB device's cumulative displacement relative to a particular reference start time, such as a particular time at which the TMU 200 was activated and/or received or established a reference time stamp or time/date stamp (e.g., in association with a translocation-enhanced encoding procedure or a translocation-enhanced loading procedure). In embodiments that operate using a reference start time, after receiving or establishing the reference start time, the TMU 200 can start or activate a clock or timer (e.g., an internal timer) and begin monitoring cumulative TMU displacement. If at any time following such timer activation the TMU 200 has been displaced by a cumulative distance that exceeds the cumulative maximum allowable displacement distance, the TMU 200 can generate or issue an operational state transition command.

### Representative Time-Related Aspects of TMU-WEB Device Translocation Monitoring

In addition to the foregoing, communication of translocation reference data to a TMU 200 corresponding to a given TMU-WEB device 100 in association with a translocation-enhanced encoding procedure or a translocation-enhanced loading procedure directed to the TMU-WEB device 100 can further respectively involve encoder or loading apparatus communication of a set of TMU monitoring period commands to the TMU 200. The set of TMU monitoring period commands can correspond to or establish one or more manners in which the TMU 200 is to recurrently or periodically monitor/measure net TMU/TMU-WEB device translocation relative to the TMU's spatial zero reference location over time once the TMU processing unit 210 begins monitoring or calculating net such net TMU translocation.

As a representative example, a set of TMU monitoring period commands communicated to a TMU 200 under consideration can define or specify that the TMU 200 (a) recurrently or periodically estimate or determine net TMU translocation relative to the TMU's spatial zero reference location in accordance with a first monitoring frequency (e.g., one or more times per second) during a first monitoring time period (e.g., 4-12 hours after the processing unit 210 begins calculating such net TMU translocation); and (b) transition to a power saving mode after expiration of the first time period, in which the TMU 200 periodically estimates or determines such net TMU translocation in association with a lower or reduced second monitoring frequency (e.g., once per minute) during a longer second time period (e.g., 1-10 days) or on an ongoing basis.

As another representative example, a set of TMU monitoring period commands communicated to a TMU 200 under consideration can define or specify that the TMU 200 (a) recurrently or periodically estimate, determine, or calculate net TMU translocation relative to the TMU's spatial zero reference location in accordance with a first monitoring frequency (e.g., one or more times per second, or every 1-10 seconds) during a first monitoring time period (e.g., 4-8 hours after the processing unit 210 begins calculating such net TMU translocation); (b) recurrently or periodically estimate such net TMU translocation in accordance with a lower second monitoring frequency (e.g., once every 1-5 minutes) during an equivalent or longer second monitoring time period (e.g., 12 hours after expiration of the first monitoring time period); and possibly (c) transition to a deep power saving mode during which the TMU 200 estimates such TMU translocation in accordance with an equivalent or further lowered or further reduced monitoring frequency (e.g., once every 1-10 minutes) during a further lengthened third monitoring time period (e.g., 1-4 weeks) or on an ongoing basis after expiration of the second time period.

If during a monitoring time period outside of the first monitoring time period (e.g., a second monitoring time period or a third monitoring time period such as set forth above) the TMU 200 determines that translocation of the TMU 200 (e.g., beyond a minimum translocation threshold such as 0.1-0.5 meters) has occurred or has likely occurred, the TMU 200 can automatically transition back to net TMU translocation monitoring in accordance with the first monitoring frequency, for instance, during a repeated first time period.

Although monitoring or estimating net TMU translocation relative to the spatial zero reference location on a less frequent or progressively less frequent basis reduces the accuracy of net TMU translocation distance estimation or calculation, such reduced frequency TMU translocation monitoring saves power and thus prolongs TMU power source lifespan. Moreover, in various situations, a most likely time interval that a given TMU-WEB device 100a carrying a corresponding TMU 200 will be translocated or displaced beyond its maximum allowable net displacement distance or a set of geofence boundaries relative to the TMU's spatial zero reference position is upon completion of a translocation-enhanced encoding procedure or translocation-enhanced loading procedure and before the given TMU-WEB device 100a resides in its intended borehole 5a. Consequently, the accuracy of net TMU translocation distance estimation or calculation relative to the TMU's spatial zero reference location can generally be high or highest during this most likely time interval.

Further to the foregoing, if during one or more monitoring time periods (e.g., at any time) the TMU 200 determines that translocation of the TMU 200 is actively occurring, is likely actively occurring, or has very recently occurred, for instance, as indicated by TMU 200 determination that one or more most-recent displacements of the TMU 200 indicate that the TMU 200 has been moved by at least a predetermined, selectable, or programmable minimum displacement distance threshold (e.g., a progressively accumulated curvilinear distance of 0.1-0.5 meters, or a net translocation distance of 0.25-0.75 meters), the TMU 200 can automatically transition to operating at a high, higher, or highest translocation monitoring frequency (e.g., calculating approximate or estimated net TMU translocation every 0.25-0.5 seconds) during a near-continuous or quasi-continuous monitoring time interval, and/or until the TMU 200 determines that translocation of the TMU 200 has stopped or likely stopped or has been interrupted or likely interrupted for a predetermined, selectable, or programmable minimum stationary/near-stationary time interval, for instance, at least 2-5 minutes.

### TMU-WEB Device Translocation Monitoring Relative to Multiple Spatial Zero Reference Points

In some embodiments, more than one spatial zero reference point and/or more than one set of geofence boundaries (e.g., where each set of geofence boundaries corresponds to a different, distinguishable, or unique geofence) can be established or stored in a given TMU-WEB device 100a. The TMU 200 carried by the given TMU-WEB device 100a can estimate, monitor, track, or calculate the TMU's translocation or spatial displacement (e.g., net and/or cumulative spatial displacement) relative to each spatial zero reference point and/or set of geofence boundaries (e.g., at particular times), and can selectively generate or issue an operational state transition command such that the TMU-WEB device 100a can transition to a different operational state (e.g., safe/standby mode or a reset/disabled/inoperative state) in a manner correlated with or based on such TMU translocation.

FIGS. 6E-6F illustrate non-limiting representative aspects of TMU-WEB device translocation monitoring relative to multiple spatial zero reference points P₁, P₂ and/or multiple sets of geofence boundaries G₁, G₂ (e.g., each of which defines a geofence corresponding to a different or distinguishable physical spatial volume) at particular times.

Individuals having ordinary skill in the relevant art will understand that in some commercial blasting environments or situations, multiple TMU-WEB devices 100 can be encoded at or within a group encoding area (e.g., a common or the same physical spatial area) that may be, for instance, between 10-200 meters away from an array of boreholes 5 into which the TMU-WEB devices 100 are to be loaded. Once any given TMU-WEB device 100a has been encoded at the group encoding area, it should subsequently be transported from the group encoding area to a loading site proximate or adjacent to a particular individual borehole 5a into which this TMU-WEB device 100a is to be loaded.

More particularly, for a given TMU-WEB device 100a, during a translocation-enhanced encoding procedure that occurs at the group encoding area, the TMU 200 of the given TMU-WEB device 100a can be programmed to store a first spatial zero reference point P₁ as shown in FIG. 6E, or a first set of geofence boundaries G₁ as shown in FIG. 6F. The TMU 200 can also be programmed to store a first maximum allowable displacement distance corresponding to the first spatial zero reference point P₁. The TMU 200 can next automatically begin monitoring TMU translocation or displacement relative to the first spatial zero reference point P₁ or the first set of geofence boundaries G₁, e.g., in a manner indicated above. If this TMU-WEB device 100a is translocated or displaced beyond the first maximum allowable displacement distance relative to the first spatial zero reference point P₁, or outside of the first set of geofence boundaries G₁, the TMU 200 can generate or issue an operational state transition command in a manner previously described.

After the TMU-WEB device 100a has been moved from the group encoding area to its loading site proximate or adjacent to the particular borehole 5a into which the given TMU-WEB device 100a is to be loaded, as part of a translocation-enhanced loading procedure the TMU 200 of the given TMU-WEB device 100a can be programmed to store a second spatial zero reference point P₂ as shown in FIG. 6E, or a second set of geofence boundaries G₂ as shown in FIG. 6F. The TMU 200 can also be programmed to store a second maximum allowable displacement distance corresponding to the second spatial zero reference point P₂. After the TMU 200 has received or stored the second spatial zero reference point P₂ and the second maximum allowable displacement distance, or has received or stored the second set of geofence boundaries G₂, the TMU 200 can automatically stop monitoring TMU translocation or displacement relative to the first spatial zero reference point P₁ or the first set of geofence boundaries G₁, and automatically begin monitoring TMU translocation or displacement relative to the second spatial zero reference point P₁ or the second set of geofence boundaries G₁ (e.g., in a manner indicated above). If this TMU-WEB device 100a is translocated or displaced beyond the second maximum allowable displacement distance relative to the second spatial zero reference point P₂, or outside of the second set of geofence boundaries G₂, the TMU 200 can generate or issue an operational state transition command in a manner described above.

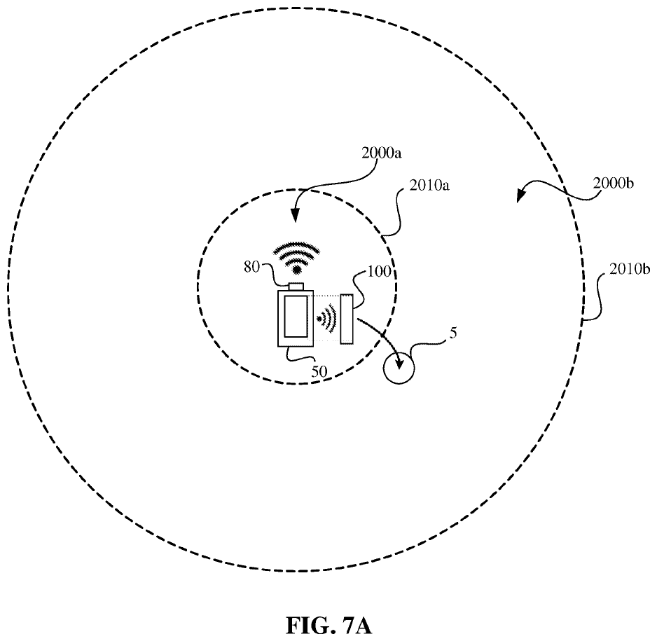

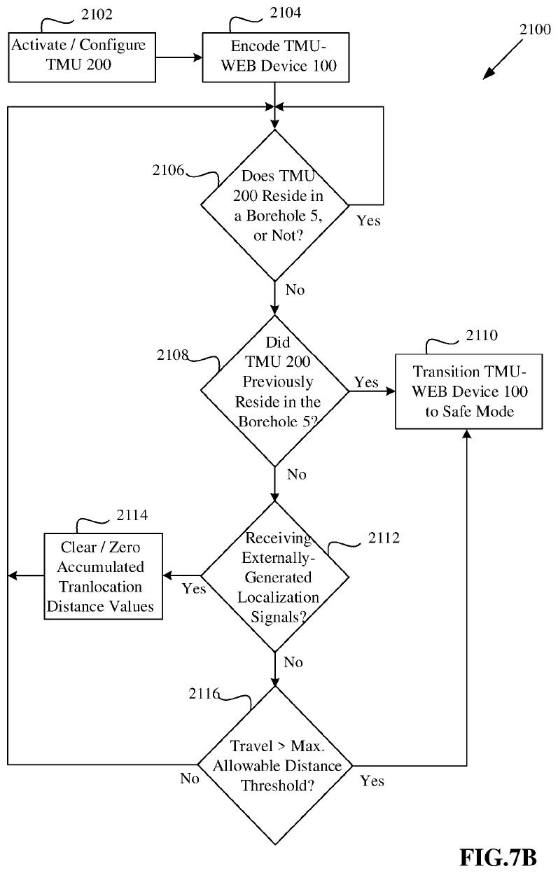

FIG. 7A is a schematic illustration of a representative set of spatial zones/regions/locations or position ranges, perimeters, or geofences 2000a,b and a representative set of translocation distance thresholds 2010a,b definable or defined in accordance with particular embodiments of the present disclosure. FIG. 7B is a flow diagram of a representative TMU-WEB device translocation-based operational state management process 2100 in accordance with an embodiment of the present disclosure, associated with or corresponding to the representative set of spatial zones/regions/locations or position ranges, perimeters, or geofences, and a representative set of translocation distance thresholds shown in FIG. 7A.

More particularly, FIG. 7A shows a first spatial zone 2000a corresponding to or defining a spatial region, perimeter, or geofence within which externally-generated localization signals output by a geofence/beacon unit 80 are detectable or reliably detectable by a TMU-WEB device 100 that is being or which has been programmed/encoded by an encoder 50 (e.g., which resides at a current location of an encoding station). In the representative embodiment shown in FIG. 7A, the geofence/beacon unit 80 is coupled to or carried by the encoder 50 or disposed at the encoding station corresponding to the encoder 50, which is typically positioned near or proximate or adjacent to a borehole 5 into which the TMU-WEB device 100 is to be loaded after it has been encoded. The borehole 5 can be, for instance, an approximately or generally vertical borehole 5 having a depth between approximately 10-40 meters, depending upon a commercial blasting operation under consideration, and/or one or more properties or characteristics of a geological formation corresponding to a mine bench in which the borehole 5 is formed, in a manner understood by individuals having ordinary skill in the relevant art.

The first spatial zone 2000a can be defined as a first spatial region or first geofence within which the presence of an encoded or operational TMU-WEB device 100 is expected to be most-safe, most expected, or least unexpected (e.g., because during and shortly after its encoding, the TMU-WEB device 100 is or is likely to be near or adjacent to the borehole 5 into which it is intended to be loaded). A first translocation distance threshold 2010a can be defined as a radial distance away from the encoder's geofence/beacon unit 80 at which externally-generated localization signals are expected to be (a) below a minimum acceptable signal strength, level, amplitude, or magnitude threshold, or (b) not reliably detectable or not detectable.

In several embodiments, the geofence/beacon unit 80 includes or is a Bluetooth™ beacon device, and the first translocation distance threshold 2010a can be between approximately 20-30 meters (e.g., depending upon the capabilities and/or configuration of the Bluetooth™ beacon device, and possibly a current state of the power source(s) that power the output or transmission of the externally-generated localization signals produced by the Bluetooth™ beacon device). Hence, the radius of the first spatial zone 2000a can correspondingly be between approximately 20-30 meters, defined with respect to a current spatial location of the geofence/beacon unit 80 at any given time.

A second spatial zone 2000b can be defined as a second spatial region or geofence within which the TMU 200 of the TMU-WEB device 100 cannot reliably detect or detect externally-generated localization signals output by the geofence/beacon unit 80, yet within which the presence of an encoded or operational TMU-WEB device 100 is still expected to be generally safe or acceptable (e.g., due to reasonable/general, though perhaps non-ideal, proximity of the TMU-WEB device 100 to the spatial location of the borehole 5 into which it is intended or expected to be loaded). A second translocation distance threshold 2010b can be defined as a (selected) maximum translocation distance that the TMU-WEB device 100 can be translocated or displaced relative to or away from a set of (selected) spatial reference locations without its TMU 200 issuing an operational state transition command to transition the TMU-WEB device 100 to a safe/standby mode or a reset/disabled state. The set of spatial reference locations can include or be (a) a first spatial reference zero point associated with or corresponding to a spatial location at which the TMU-WEB device 100 was encoded; and/or (b) a second spatial reference zero point corresponding to a spatial location at which the TMU 200 of the TMU-WEB device 100 determines that externally-generated localization signals are no longer reliably detectable or detectable. In a number of embodiments, the second translation distance threshold 2010b can be between approximately 50-400 meters (e.g., between approximately 100-300 meters, or about 200 meters, or about 300 meters, depending upon a commercial blasting operation under consideration and environmental/situational details) away from the first spatial reference zero point or the second spatial reference zero point. Once the TMU-WEB device 100 has been translocated beyond the second translocation distance threshold 2010b, its TMU 200 generates or issues an operational state transition signal or command to transition the TMU-WEB device 100 to a safe/standby mode or a reset/disabled state.

With further reference to FIG. 7B, a TMU-WEB device translocation-based operational state management process 2100 includes a first process portion 2102 involving activating and configuring the TMU 200 of a given TMU-WEB device 100 for operation, which can possibly include the communication or transfer of a minimum externally-generated localization signal strength, level, amplitude or magnitude threshold and/or a set of spatial localization data to the TMU 200. A second process portion 2104 involves encoding the TMU-WEB device 100 by way of an encoder 50. A third process portion 2106 involves TMU determination of whether or not the TMU-WEB device 100 to which it corresponds currently resides in a borehole 5.

In several embodiments, the TMU 200 can determine that the TMU-WEB device 100 has been loaded into and currently resides in the borehole 5 by monitoring, tracking, estimating, or calculating TMU displacement along at least one spatial dimension (e.g., a vertical or horizontal dimension corresponding to one principal axis) corresponding to the expected spatial orientation of the borehole (e.g., an approximately vertical or approximately horizontal orientation, respectively), followed by TMU confirmation that its displacement has ceased (e.g., for a certain period of time, such as 30 minutes or 1 or more hours) after traveling a likely or expected in-borehole deployment distance (e.g., 50-80% of the borehole's expected or approximate depth or length). Additionally or alternatively, in certain embodiments the TMU 200 can determine that the TMU-WEB device 100 has been loaded into and currently resides in the borehole 5 by way of signal communication with a loading apparatus at one or more times during a translocation-enhanced loading procedure. Once the TMU 200 determines that it has been loaded into and resides in the borehole 5, the TMU 200 can set a loading completion/borehole residence flag.

The TMU 200 can determine that it does not currently reside in the borehole 5 by further checking the state of the loading completion/borehole residence flag at one or more times, or by monitoring, tracking, estimating, or calculating TMU displacement along the at least one spatial dimension in a set of directions opposite to the direction(s) corresponding to borehole loading (e.g., toward, to, and possibly out of the borehole opening or collar). The TMU 200 can ignore small or very small TMU displacements in the set of directions opposite to the direction(s) corresponding to borehole loading, such as displacements that may occur due to vibrations or shocks conveyed or imparted to the TMU 200 in association with the explosive initiation and detonation of explosive materials in other boreholes 5. If the TMU 200 determines that it does not reside in the borehole 5, it can set a borehole exit flag.

If the TMU 200 determines that it currently resides in the borehole 5 (e.g., by way of checking the states of the loading completion/borehole residence flag and the borehole exit flag), the process 2100 can simply recurrently return to the third process portion 2106. Otherwise, if the TMU 200 determines that it currently does not reside in the borehole 5, a fourth process portion 2108 can involve TMU determination of whether it had previously resided in the borehole 5 (e.g., by checking the state of the loading completion/borehole residence flag). If the TMU 200 determines that it had previously resided in the borehole 5, but does not currently reside in the borehole 5 (e.g., by determining that the loading completion/borehole residence flag has been set, and the borehole exit flag has also been set), then a fifth process portion 2110 involves TMU generation or issuance of an operational state transition signal or command by which the TMU-WEB device 100 can transition to a safe/standby mode or a reset/disabled state.

If by way of the third and fourth process portions 2106, 2108 the TMU 200 determines that it is not resident in the borehole 5 and had not previously been loaded into the borehole 5, a sixth process portion 2112 involves TMU determination of whether externally-generated localization signals are currently being reliably received (e.g., indicating that the TMU 200 is within reliable signal reception range of at least one geofence/beacon unit 80, and is receiving geofence/beacon signals output thereby). If so, a seventh process portion 2114 involves the TMU 200 clearing, resetting, or zeroing any accumulated translocation distance values (data) (e.g., a set of accumulated translocation values corresponding to displacement along one or more spatial dimensions) generated and stored by way of its IMU 210, after which the process 2100 can return to the third process portion 2106. If the TMU 200 determines in the sixth process portion 2112 that externally-generated localization signals are not currently being reliably received, an eighth process portion 2116 involves TMU determination of whether any accumulated translocation value(s) (data) generated and stored by the way of its IMU 210 indicate that the TMU 200 has spatially travelled or has been translocated (either on a cumulative or net basis, depending upon embodiment details) by more than a maximum acceptable translocation distance threshold. If so, the process 2100 can proceed to the fifth process portion 2110, in association with which the operational state of the TMU-WEB device 100 can be transitioned to a safe/standby mode or a reset/disabled state. If the TMU 200 has not travelled or has not been translocated by more than the maximum acceptable translocation distance threshold, the process 2100 can return to the third process portion 2106.

The above description details aspects of particular systems, apparatuses, devices, methods, processes, and procedures in accordance with particular non-limiting representative embodiments of the present disclosure. It will be readily understood by a person having ordinary skill in the relevant art that modifications can be made to one or more aspects or portions of these and related embodiments without departing from the scope of the present disclosure. For instance, an externally-generated localization signal reception unit 234 can be a built-in or as-manufactured part of a wireless initiation device, which otherwise lacks an IMU 210; and an add-on (e.g., snap-on/screw-on) TMU 200 that carries an IMU 210 (e.g., along with additional TMU elements), but which need not or does not carry an (other) externally-generated localization signal reception unit 234, can be coupled or attached to the wireless initiation device to form a TMU-WEB device 100. This and other modifications are encompassed by the scope of the present disclosure.

1. A commercial blasting system comprising at least one commercial blasting system element configured to wirelessly communicate with a remote blast control system while residing in a borehole, wherein each commercial blasting system element includes a Translocation Monitoring Unit (TMU) and each commercial blasting system element is in the form of:
a TMU-equipped wireless initiation device including a wireless initiation device having a TMU corresponding thereto which is carried by or incorporated in the wireless initiation device, wherein the wireless initiation device is configured to wirelessly communicate with the remote blast control system by way of through-the-earth (TTE) wireless signals while the wireless initiation device and its corresponding TMU reside in the borehole, and wherein the TMU corresponding to the wireless initiation device includes:
an Inertial Measurement Unit (IMU) configured to measure spatial displacement of the IMU based on one or more movement sensors of the IMU;
an electronic processing unit; and
a memory coupled to the electronic processing unit having instructions stored therein that when executed by the electronic processing unit enable selective self-contained or independent management or control of an operational state of the wireless initiation device to which the TMU corresponds, and which cause the electronic processing unit to:
evaluate a spatial displacement of the wireless initiation device based on the measured spatial displacement of the IMU;
determine based on the evaluated spatial displacement of the wireless initiation device whether the wireless initiation device should or needs to be transitioned to a safe and/or standby mode or a reset and/or disabled state; and
selectively generate and issue a state transition signal and/or command, by which the wireless initiation device is transitioned to a safe and/or standby mode or a reset and/or disabled state, after the wireless initiation device has been programmed and/or encoded, if the evaluated spatial displacement is greater than at least one translocation distance threshold, such that the wireless initiation device automatically transitions to the safe and/or standby mode or the reset and/or disabled state based on the evaluated spatial displacement.

2. The system of claim 1, wherein the instructions further cause the electronic processing unit to:
transition the state to the safe and/or standby mode or the reset and/or disabled state when the evaluated spatial displacement is greater than:
a first translocation distance threshold defined as a maximum translocation distance from one or more spatial reference locations; and/or
a second translocation distance threshold corresponding substantially to a borehole depth following loading of the wireless initiation device into the borehole.

3. The system of claim 1, wherein the instructions further cause the electronic processing unit to:
transition the state to a fully enabled and/or fully activated operational state, in which the wireless initiation device can process and carry out a FIRE command, or an ARM command followed by a FIRE command, after the wireless initiation device has been programmed and/or encoded, when the evaluated spatial displacement is greater than a selected significant fraction of the borehole in a direction toward a borehole location at which the wireless initiation device is intended to be disposed according to a blast plan.

4. The system of claim 1, wherein the one or more movement sensors internal to the IMU are configured to measure the spatial displacement relative to or along or in one, two or three orthogonal spatial directions or dimensions or axes, and wherein the one or more movement sensors include at least one accelerometer, one gyroscope, and optionally one magnetometer per axis for each of one, two or three of the three orthogonal spatial directions or dimensions or axes.

5. The system of claim 1, wherein the wireless initiation device further comprises:
a Communication and Control (CC) unit; and
an initiation element and/or an initiation unit configured for initiating an explosive composition.

6. The system of claim 1, wherein the TMU is couplable to the wireless initiation device, and wherein the TMU includes a TMU housing module, and wherein the TMU is further configured for wire-based and/or wireless communication with a communication unit and/or an initiation control unit in the wireless initiation device.

7. The system of claim 6, wherein the TMU is configured to be turned on, powered up, and/or transitioned from an inactive, quiescent, sleep, and/or standby mode to an active state by way of coupling of the TMU housing module to the wireless initiation device.

8. The system of claim 1, further comprising: one or more switches and/or buttons carried by the TMU and/or the wireless initiation device, wherein the TMU is configured to be turned on and/or powered up or transitioned from an inactive quiescent, sleep, and/or standby mode to an active state by way of activation of the one or more switches and/or buttons.

9. The system of claim 1, further comprising: one or more visual indicator devices, carried by the TMU and/or the wireless initiation device, configured for outputting at least one signal or datum and/or data indicating a current status or state of the system based on a current or most-recent TMU spatial location determined from the evaluated spatial displacement, optionally wherein the TMU is configured to output visual indicator signals for the visual indicator devices for visibly or visually indicating a current state of the TMU and/or the wireless initiation device.

10. The system of claim 1, wherein the electronic processing unit and the memory comprises: integrated circuitry configured for tracking, estimating, detecting, monitoring, measuring, and/or determining a current spatial zone, region, location, position and/or displacement of the TMU relative to externally-generated localization signals that have been received, and/or spatial reference location data, in accordance with the instructions stored in the memory that are executed by the electronic processing unit.

11. The system of claim 1, further comprising: an encoder, wherein the encoder is configured to send signals to the TMU comprising one or more of:
to power up, wake up, or transition the TMU to a responsive, active, or fully active state;
to output or communicate externally-generated localization signals in proximity to, in the vicinity of, or toward or to the TMU by way of a geofence and/or beacon unit carried by, couplable and/or attachable to, or built into the encoder;
to transfer to the TMU a minimum acceptable signal strength, level, amplitude, or magnitude threshold corresponding to reliable detection of the externally-generated localization signals;
to transfer to the TMU a spatial reference location correlated with or corresponding to a current geospatial location of the encoder and defining a spatial zero reference location or point for the TMU; and/or
to transfer to the TMU data establishing, for the TMU and/or wireless initiation device, at least one maximum allowable displacement distance and/or one or more geofence boundaries defined with respect to a/the spatial reference location.

12. The system of claim 1, further comprising: one or more localization signal sources, and optionally including:
an encoder carrying at least one of the one or more localization signal sources;
a loading system carrying at least one of the one or more localization signal sources; and/or
one or more ground-based platform structures carrying at least one of the one or more localization signal sources.

13. The system of claim 1, including a loading system with a communication unit configured to generate signals and/or commands shortly or just before or as the wireless initiation device is loaded into the borehole, wherein on receipt of the signals and/or commands, the TMU and the instructions further cause the electronic processing unit to:
transition the state to a fully enabled or fully activated operational state, in which the wireless initiation device can process and carry out a FIRE command, or an ARM command followed by a FIRE command;
activate the TMU;
clear, reset, and/or zero any accumulated translocation and/or movement values generated and stored by way of the IMU;
establish a spatial zero reference location of the TMU; and/or
initiate TMU monitoring of net TMU device translocation by the measurement spatial displacement, wherein the loading system optionally includes a magazine configured to store a plurality of wireless initiation devices, and wherein the loading system optionally carries at least one of the one or more localization signal sources.

14. The system of claim 1, wherein the instructions further cause the electronic processing unit to:
determine whether externally-generated localization signals are currently being reliably received; and if so,
clear, reset, and/or zero any accumulated translocation distance values generated and stored by way of the IMU.

15. A method of managing or controlling an operational state of a wireless initiation device by way of a Translocation Monitoring Unit (TMU), the method comprising:
providing a TMU-equipped wireless initiation device configured to reside in a borehole and which is configured to wirelessly communicate with a remote blast control system while residing in the borehole, wherein the TMU-equipped wireless initiation device includes a wireless initiation device having a TMU corresponding thereto which is carried by or incorporated in the wireless initiation device, wherein the wireless initiation device is configured to wirelessly communicate with the remote blast control system by way of through-the-earth (TTE) wireless signals while the wireless initiation device and its corresponding TMU reside in the borehole, and wherein the TMU corresponding to the wireless initiation device includes:
an Inertial Measurement Unit (IMU) configured to measure spatial displacement of the IMU based on one or more movement sensors of the IMU;
an electronic processing unit; and
a memory coupled to the electronic processing unit having instructions stored therein that when executed by the electronic processing unit enable selective self-contained or independent management or control of an operational state of the wireless initiation device;
automatic TMU evaluation, by way of electronic processing unit instruction execution, of spatial displacement of the wireless initiation device based on measured spatial displacement of the IMU;
automatic TMU determination, by way of electronic processing unit instruction execution, of whether the wireless initiation device should or needs to be transitioned to a safe and/or standby mode or reset and/or disabled state, including when the TMU resides in the borehole, based on the automatic TMU evaluation of spatial displacement of the wireless initiation device; and
automatic TMU generation and issuance, by way of electronic processing unit instruction execution, of a state transition signal and/or command by which the wireless initiation device can be or is transitioned to a safe and/or standby mode or a reset and/or disabled state, after the wireless initiation device has been programmed and/or encoded, if the evaluated spatial displacement of the wireless initiation device is greater than at least one translocation distance threshold, such that the wireless initiation device automatically transitions its operational state based on the evaluated spatial displacement.

16. The system of claim 1, wherein the TMU includes an externally-generated localization signal reception unit configured to wirelessly receive one or more types of externally-generated localization signals transmitted by one or more localization signal sources disposed external to the TMU and external to the wireless initiation device, and wherein the electronic processing unit and memory are configured to evaluate the spatial displacement of the wireless initiation device based on the measured spatial displacement of the IMU and the externally-generated localization signals.

17. The system of claim 16, wherein the electronic processing unit and memory are configured to transition the state to the safe and/or standby mode or the reset and/or disabled state when the evaluated spatial displacement is greater than a first translocation distance threshold defined as a radial distance away from a geofence and/or beacon unit.
